(19) United States
(12) Patent Application Publication
(10) Pub. No.: US 2023/0125661 A1
(43) Pub. Date: Apr. 27, 2023

(54) SYSTEMS AND METHODS FOR DETECTING AND PREDICTING VIRTUAL CPU RESOURCE STARVATION OF A VIRTUAL MACHINE

(71) Applicant: Citrix Systems, Inc., Fort Lauderdale, FL (US)

(72) Inventors: Nirmalanand Jebakumar, Bangalore (IN); Ashutosh Sharma, Bangalore (IN)

(73) Assignee: Citrix Systems, Inc., Fort Lauderdale, FL (US)

(21) Appl. No.: 17/508,326

(22) Filed: Oct. 22, 2021

(51) Int. Cl. G06F 9/48; G06F 9/455

(52) U.S. Cl. CPC G06F 9/4887; G06F 9/4837; G06F 9/45558; G06F 2009/4557

(57) ABSTRACT

Described embodiments provide systems and detecting and predicting virtual CPU resource starvation of a virtual machine. One or more processors can determine, within a time period, a count of a number of delays in occurrences of a timer interrupt scheduled for a virtual processor of a virtual machine executing an application. The one or more processors can compare the count of the number of delays with a threshold established for the time period. The one or more processors can execute a process to migrate the application to a second one or more processors based at least on the comparison of the count of the number of delays with the threshold.

### FIELD OF THE DISCLOSURE

This application generally relates to managing resource distribution, including but not limited to systems and methods for detecting and predicting virtual CPU resource starvation of a virtual machine.

### BACKGROUND

Client devices can communicate with servers via established communication channels. The user of the client device can be assigned a virtual machine hosted on the server. The client device can establish a session with the assigned virtual machine. The client device can access applications and resources via the established session with the virtual machine. The server can schedule operations on the virtual machine.

### SUMMARY

In a virtualized environment, a host system (e.g., a server) can deploy virtual machines (VMs). The host system can schedule tasks on one or more VMs, such as periodic tasks co-existing on the same virtualized environment. However, due to various VMs deployed on the same host system, it can be challenging to identify resource starvation (e.g., lack of resources during high traffic) causing momentary or periodic resource spikes affecting operations or tasks to execute on VMs. For instance, due to resource starvation, execution of tasks by virtual central processing units (vCPUs) of VMs may be delayed even with resource reservation. This delay can impact active workload on the vCPU leading to issues, such as failover, packet processing delays, protocol timer expiry, etc., causing connection loss or downtime.

Further, in environments where a cloud service provider manages the host system or the administrator does not have visibility of the status (e.g., tenancy, over-commitment, etc.) of the host system, it can be difficult to determine the causes of performance impact. For example, the host system may lack the capability to classify application impact either due to issues with the VMs or the underlying host environment.

The systems and methods of this technical solution can detect occurrences of vCPU scheduling delays (e.g., occurrences of resource starvations). The vCPU scheduling can represent the scheduling of a timer interrupt. For example, the systems and methods can detect instances of the timer interrupt scheduling and instances when the timer interrupt is triggered. The systems and methods can determine whether the timer interrupt should be considered as an occurrence of a delay based on the delta between expected and actual interrupt fire time. The systems and methods can record occurrences of the delays to generate historical data. The systems and methods can predict scheduling delays based on the historical data. The systems and methods can perform one or more actions to mitigate the vCPU scheduling delays of the VM. The actions can include at least migrating workloads to a different VM or a different host system.

Thus, by detecting and predicting resource starvation, the systems and methods described herein can at least mitigate resource starvation impact on VMs or vCPUs, thereby increasing the performance and reliability of the VMs. Further, by taking an action based on the historical data, the systems and methods can reduce delays of scheduling one or more vCPUs, decrease packet drop rate, improve the reliability of the VM, increase the efficiency of packet processing on various vCPUs, and improve user experiences using the VMs.

In one aspect, this disclosure is directed to a method for detecting and predicting virtual CPU resource starvation of a virtual machine. The method can include determining, one or more processors, within a time period a count of a number of delays in occurrences of a timer interrupt scheduled for a virtual processor of a virtual machine executing an application. The method can include comparing, by the one or more processors, the count of the number of delays with a threshold established for the time period. The method can include executing, by the one or more processors, a process to migrate the application to a second one or more processors based at least on the comparison of the count of the number of delays with the threshold.

The method can include determining, by the one or more processors, the threshold based on a time of a day associated with the time period. The method can include determining, by the one or more processors, the threshold based on the application executed by the virtual machine. The method can include determining, by the one or more processors, the threshold based on a model trained using historical performance data associated with one or more virtual processors of one or more virtual machines executed by the one or more processors.

The time period may include a future time period. Determining the count of the number of delays can include predicting, by the one or more processors using a model trained with historical timer interrupt data, the count of the number of delays for the future time period. The process can include determining, by the one or more processors, a second count of a number of delays within the time period in occurrences of a second timer interrupt scheduled for a second virtual processor of a second virtual machine. The process can include migrating, by the one or more processors based on the comparison of the count of the number of delays with the threshold, the application to the second virtual machine.

The second virtual machine may be hosted by the one or more processors. The process can include launching, by the one or more processors, a second virtual machine responsive to the count of the number of delays greater than the threshold. The process can include migrating, by the one or more processors, the application to the second virtual machine.

The process can include migrating, by the one or more processors, the virtual machine to the second one or more processors. The method can include instructing, by the one or more processors responsive to the count of the number of delays greater than or equal to the threshold, a bus adapter for the virtual machine to perform at least one of prioritizing transmission and reception of protocol control packets, or increase, by the bus adapter, a queue depth of the bus adapter.

In another aspect, this disclosure is directed to a system for detecting and predicting virtual CPU resource starvation of a virtual machine. The system can include one or more processors of a device. The one or more processors can determine within a time period a count of a number of delays in occurrences of a timer interrupt scheduled for a virtual processor of a virtual machine executing an application. The one or more processors can compare the count of the number of delays with a threshold established for the time period. The one or more processors can execute a process to migrate the application to a second one or more processors based at least on the comparison of the count of the number of delays with the threshold.

The one or more processors can determine the threshold based on a time of a day associated with the time period. The one or more processors can determine the threshold based on the application executed by the virtual machine. The one or more processors can determine the threshold based on a model trained using historical performance data associated with one or more virtual processors of one or more virtual machines executed by the one or more processors.

The time period may include a future time period. The one or more processors can execute the process to predict, using a model trained with historical timer interrupt data, the count of the number of delays for the future time period to determine the count. The one or more processors can execute the process to determine a second count of a number of delays within the time period in occurrences of a second timer interrupt scheduled for a second virtual processor of a second virtual machine. The one or more processors can execute the process to migrate, based on the comparison of the count of the number of delays with the threshold, the application to the second virtual machine.

The one or more processors can execute the process to launch a second virtual machine responsive to the count of the number of delays greater than the threshold. The one or more processors can execute the process to migrate the application to the second virtual machine. The one or more processors can instruct, responsive to the count of the number of delays greater than or equal to the threshold, a bus adapter for the virtual machine to perform at least one of prioritize transmission and reception of protocol control packets, or increase a queue depth of the bus adapter.

In another aspect, this disclosure is directed to a non-transitory computer readable medium for detecting and predicting virtual CPU resource starvation of a virtual machine. The non-transitory computer readable medium can store instructions that, when executed by the one or more processors, causes the one or more processors to determine within a time period a count of a number of delays in occurrences of a timer interrupt scheduled for a virtual processor of a virtual machine executing an application. The instructions can cause the one or more processors to compare the count of the number of delays with a threshold established for the time period. The instructions can cause the one or more processors execute a process to migrate the application to a second one or more processors based at least on the comparison of the count of the number of delays with the threshold.

The instructions can include instructions to determine the threshold based on a time of a day associated with the time period.

These and other aspects and implementations are discussed in detail below. The foregoing information and the following detailed description include illustrative examples of various aspects and implementations, and provide an overview or framework for understanding the nature and character of the claimed aspects and implementations. This Summary is not intended to identify key features or essential features, nor is it intended to limit the scope of the claims included herewith. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2A is a block diagram of an example system in which resource management services may manage and streamline access by clients to resource feeds (via one or more gateway services) and/or software-as-a-service (SaaS) applications;

FIG. 2B is a block diagram showing an example implementation of the system shown in FIG. 2A in which various resource management services as well as a gateway service are located within a cloud computing environment;

FIG. 2C is a block diagram similar to that shown in FIG. 2B but in which the available resources are represented by a single box labeled “systems of record,” and further in which several different services are included among the resource management services;

FIG. 3 is a block diagram of an example system for detecting and predicting virtual CPU resource starvation of a virtual machine, in accordance with one or more implementations;

FIG. 4 is an example workflow diagram for detecting and predicting virtual CPU resource starvation of a virtual machine, in accordance with one or more implementations;

FIG. 5 is an example workflow diagram for orchestrating an action, in accordance with one or more implementations;

FIG. 6 is an example workflow diagram for handling protocol packets and data packets, in accordance with one or more implementations; and

FIG. 7 is an example flow diagram of a method for detecting and predicting virtual CPU resource starvation of a virtual machine, in accordance with one or more implementations.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein;

Section B describes resource management services for managing and streamlining access by clients to resource feeds; and

Section C describes systems and methods for detecting and predicting virtual CPU resource starvation of a virtual machine.

### A. Computing Environment

Prior to discussing the specifics of embodiments of the systems and methods of an appliance and/or client, it may be helpful to discuss the computing environments in which such embodiments may be deployed.

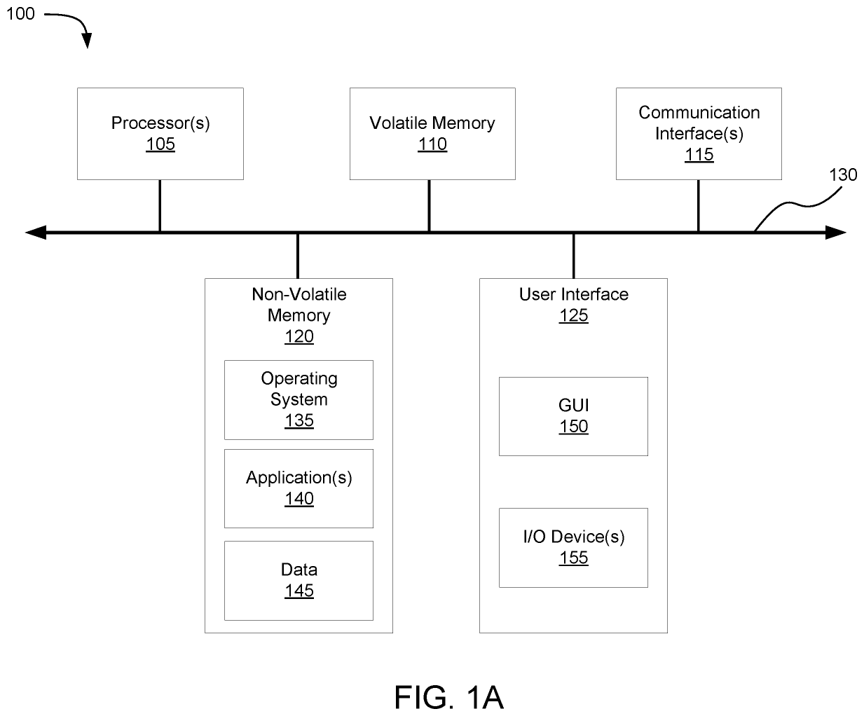

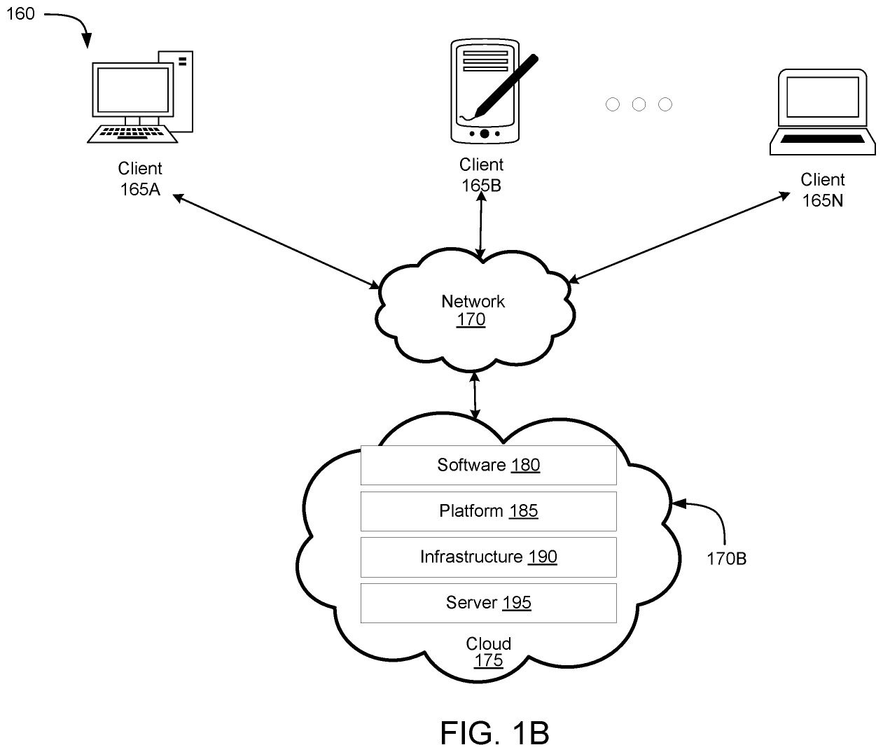

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of one or more applications, one or more desktop applications, and one or more desktop sessions in which one or more applications may execute.

Referring to FIG. 1B, a computing environment 160 is depicted. Computing environment 160 may generally be implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing, or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but are not limited to, networks, network bandwidth, servers, processing, memory, storage, applications, virtual machines, databases, software, hardware, analytics, and intelligence.

In some embodiments, the computing environment 160 may provide client 165 with one or more resources provided by a network environment. The computing environment 160 may include one or more clients 165a-165n, in communication with a cloud 175 over one or more networks 170. Clients 165 may include, e.g., thick clients, thin clients, and zero clients. The cloud 108 may include back-end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In some embodiments, the computing environment 160 can include a hybrid cloud that is a combination of a public cloud and a private cloud. For example, the cloud 175 may be public, private, or hybrid. Public clouds 108 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back-end platforms, e.g., servers, storage, server farms or data centers. For example, the cloud 175 can include or correspond to a server or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control, and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g., Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers, or virtualization resources from large pools, allowing the users to quickly scale up by accessing more resources as needed. Examples of IaaS include AMAZON WEB SERVICES provided by Amazon.com, Inc., of Seattle, Wash.; RACKSPACE CLOUD provided by Rackspace US, Inc., of San Antonio, Tex.; Google Compute Engine provided by Google Inc. of Mountain View, Calif.; or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash.; Google App Engine provided by Google Inc.; and HEROKU provided by Heroku, Inc., of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc.; SALESFORCE provided by Salesforce.com Inc. of San Francisco, Calif.; or OFFICE 365 provided by Microsoft Corporation. Examples of SaaS may also include data storage providers, e.g., DROPBOX provided by Dropbox, Inc., of San Francisco, Calif.; Microsoft SKYDRIVE provided by Microsoft Corporation; Google Drive provided by Google Inc.; or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Resource Management Services for Managing and Streamlining Access by Clients to Resource Feeds

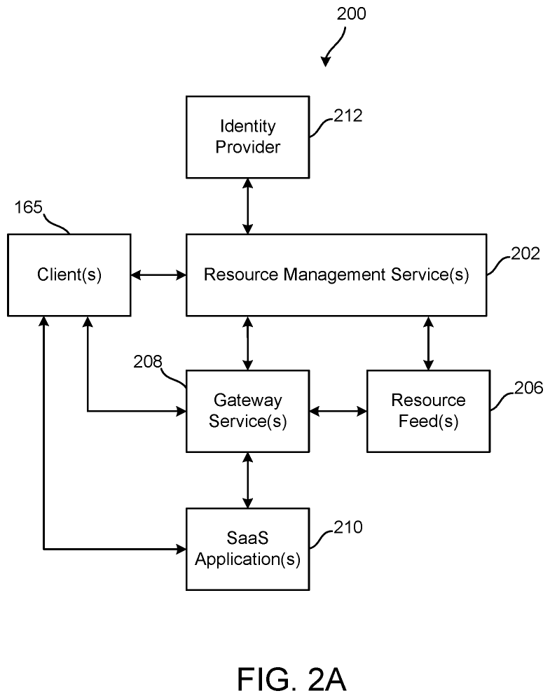

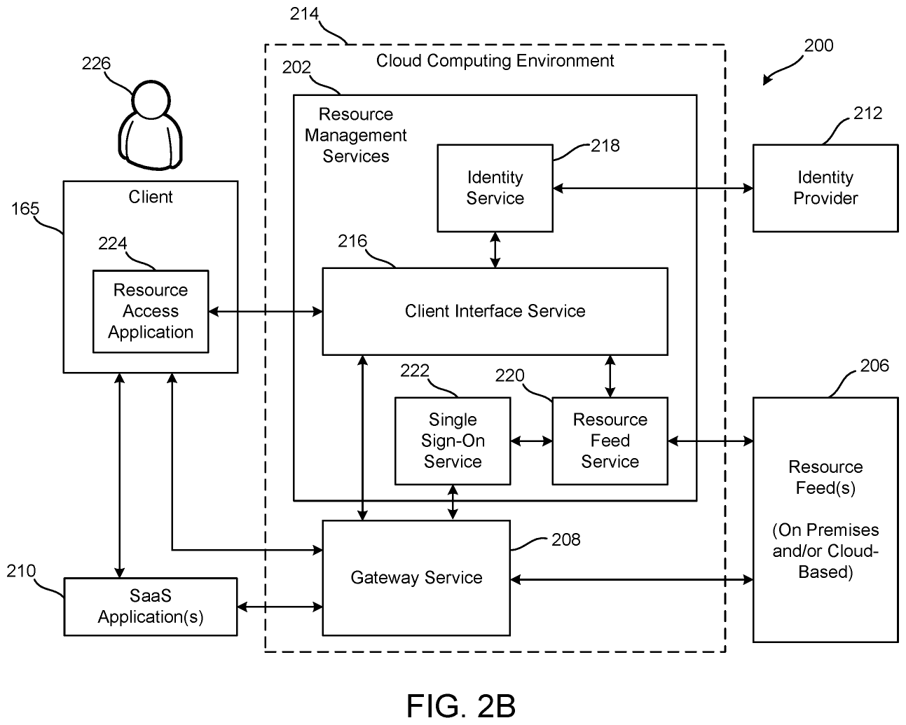

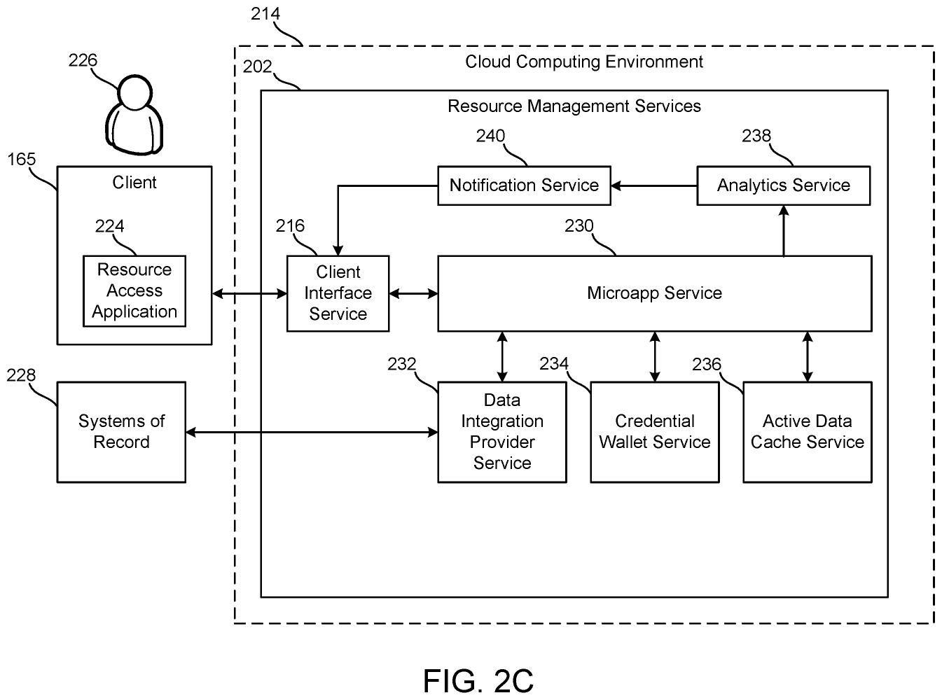

FIG. 2A is a block diagram of an example system 200 in which one or more resource management services 202 may manage and streamline access by one or more clients 165 to one or more resource feeds 206 (via one or more gateway services 208) and/or one or more software-as-a-service (SaaS) applications 210. In particular, the resource management service(s) 202 may employ an identity provider 212 to authenticate the identity of a user of a client 165 and, following authentication, identify one of more resources the user is authorized to access. In response to the user selecting one of the identified resources, the resource management service(s) 202 may send appropriate access credentials to the requesting client 165, and the client 165 may then use those credentials to access the selected resource. For the resource feed(s) 206, the client 165 may use the supplied credentials to access the selected resource via a gateway service 208. For the SaaS application(s) 210, the client 165 may use the credentials to access the selected application directly.

The client(s) 165 may be any type of computing devices capable of accessing the resource feed(s) 206 and/or the SaaS application(s) 210, and may, for example, include a variety of desktop or laptop computers, smartphones, tablets, etc. The resource feed(s) 206 may include any of numerous resource types and may be provided from any of numerous locations. In some embodiments, for example, the resource feed(s) 206 may include one or more systems or services for providing virtual applications and/or desktops to the client(s) 165, one or more file repositories and/or file sharing systems, one or more secure browser services, one or more access control services for the SaaS applications 210, one or more management services for local applications on the client(s) 165, one or more internet enabled devices or sensors, etc. Each of the resource management service(s) 202, the resource feed(s) 206, the gateway service(s) 208, the SaaS application(s) 210, and the identity provider 212 may be located within an on-premises data center of an organization for which the system 200 is deployed, within one or more cloud computing environments, or elsewhere.

FIG. 2B is a block diagram showing an example implementation of the system 200 shown in FIG. 2A in which various resource management services 202 as well as a gateway service 208 are located within a cloud computing environment 214. The cloud computing environment may, for example, include Microsoft Azure Cloud, Amazon Web Services, Google Cloud, or IBM Cloud.

For any of the illustrated components (other than the client 165) that are not based within the cloud computing environment 214, cloud connectors (not shown in FIG. 2B) may be used to interface those components with the cloud computing environment 214. Such cloud connectors may, for example, run on Windows Server instances hosted in resource locations and may create a reverse proxy to route traffic between the site(s) and the cloud computing environment 214. In the illustrated example, the cloud-based resource management services 202 include a client interface service 216, an identity service 218, a resource feed service 220, and a single sign-on service 222. As shown, in some embodiments, the client 165 may use a resource access application 224 to communicate with the client interface service 216 as well as to present a user interface on the client 165 that a user 226 can operate to access the resource feed(s) 206 and/or the SaaS application(s) 210. The resource access application 224 may either be installed on the client 165, or may be executed by the client interface service 216 (or elsewhere in the system 200) and accessed using a web browser (not shown in FIG. 2B) on the client 165.

As explained in more detail below, in some embodiments, the resource access application 224 and associated components may provide the user 226 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 224 is launched or otherwise accessed by the user 226, the client interface service 216 may send a sign-on request to the identity service 218. In some embodiments, the identity provider 212 may be located on the premises of the organization for which the system 200 is deployed. The identity provider 212 may, for example, correspond to an on-premises Windows Active Directory. In such embodiments, the identity provider 212 may be connected to the cloud-based identity service 218 using a cloud connector (not shown in FIG. 2B), as described above. Upon receiving a sign-on request, the identity service 218 may cause the resource access application 224 (via the client interface service 216) to prompt the user 226 for the user's authentication credentials (e.g., user-name and password). Upon receiving the user's authentication credentials, the client interface service 216 may pass the credentials along to the identity service 218, and the identity service 218 may, in turn, forward them to the identity provider 212 for authentication, for example, by comparing them against an Active Directory domain. Once the identity service 218 receives confirmation from the identity provider 212 that the user's identity has been properly authenticated, the client interface service 216 may send a request to the resource feed service 220 for a list of subscribed resources for the user 226.

In other embodiments (not illustrated in FIG. 2B), the identity provider 212 may be a cloud-based identity service, such as a Microsoft Azure Active Directory. In such embodiments, upon receiving a sign-on request from the client interface service 216, the identity service 218 may, via the client interface service 216, cause the client 165 to be redirected to the cloud-based identity service to complete an authentication process. The cloud-based identity service may then cause the client 165 to prompt the user 226 to enter the user's authentication credentials. Upon determining the user's identity has been properly authenticated, the cloud-based identity service may send a message to the resource access application 224 indicating the authentication attempt was successful, and the resource access application 224 may then inform the client interface service 216 of the successfully authentication. Once the identity service 218 receives confirmation from the client interface service 216 that the user's identity has been properly authenticated, the client interface service 216 may send a request to the resource feed service 220 for a list of subscribed resources for the user 226.

For each configured resource feed, the resource feed service 220 may request an identity token from the single sign-on service 222. The resource feed service 220 may then pass the feed-specific identity tokens it receives to the points of authentication for the respective resource feeds 206. Each resource feed 206 may then respond with a list of resources configured for the respective identity. The resource feed service 220 may then aggregate all items from the different feeds and forward them to the client interface service 216, which may cause the resource access application 224 to present a list of available resources on a user interface of the client 165. The list of available resources may, for example, be presented on the user interface of the client 165 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®), one or more secure browsers, one or more internet enabled devices or sensors, one or more local applications installed on the client 165, and/or one or more SaaS applications 210 to which the user 226 has subscribed. The lists of local applications and the SaaS applications 210 may, for example, be supplied by resource feeds 206 for respective services that manage which such applications are to be made available to the user 226 via the resource access application 224. Examples of SaaS applications 210 that may be managed and accessed as described herein include Microsoft Office 365 applications, SAP SaaS applications, Workday applications, etc.

For resources other than local applications and the SaaS application(s) 210, upon the user 226 selecting one of the listed available resources, the resource access application 224 may cause the client interface service 216 to forward a request for the specified resource to the resource feed service 220. In response to receiving such a request, the resource feed service 220 may request an identity token for the corresponding feed from the single sign-on service 222. The resource feed service 220 may then pass the identity token received from the single sign-on service 222 to the client interface service 216 where a launch ticket for the resource may be generated and sent to the resource access application 224. Upon receiving the launch ticket, the resource access application 224 may initiate a secure session to the gateway service 208 and present the launch ticket. When the gateway service 208 is presented with the launch ticket, it may initiate a secure session to the appropriate resource feed and present the identity token to that feed to seamlessly authenticate the user 226. Once the session initializes, the client 165 may proceed to access the selected resource.

When the user 226 selects a local application, the resource access application 224 may cause the selected local application to launch on the client 165. When the user 226 selects a SaaS application 210, the resource access application 224 may cause the client interface service 216 request a one-time uniform resource locator (URL) from the gateway service 208 as well as a preferred browser for use in accessing the SaaS application 210. After the gateway service 208 returns the one-time URL and identifies the preferred browser, the client interface service 216 may pass that information along to the resource access application 224. The client 165 may then launch the identified browser and initiate a connection to the gateway service 208. The gateway service 208 may then request an assertion from the single sign-on service 222. Upon receiving the assertion, the gateway service 208 may cause the identified browser on the client 165 to be redirected to the logon page for identified SaaS application 210 and present the assertion. The SaaS may then contact the gateway service 208 to validate the assertion and authenticate the user 226. Once the user has been authenticated, communication may occur directly between the identified browser and the selected SaaS application 210, thus allowing the user 226 to use the client 165 to access the selected SaaS application 210.

In some embodiments, the preferred browser identified by the gateway service 208 may be a specialized browser embedded in the resource access application 224 (when the resource application is installed on the client 165) or provided by one of the resource feeds 206 (when the resource application 224 is located remotely), e.g., via a secure browser service. In such embodiments, the SaaS applications 210 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (4) restricting navigation, e.g., by disabling the next and/or back browser buttons, (5) restricting downloads, e.g., by disabling the ability to download from within the SaaS application, and (6) displaying watermarks, e.g., by overlaying a screen-based watermark showing the username and IP address associated with the client 165 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 206) for assessment of its security risk by a web filtering service. For approved URLs, the specialized browser may be permitted to access the link. For suspicious links, however, the web filtering service may have the client interface service 216 send the link to a secure browser service, which may start a new virtual browser session with the client 165, and thus allow the user to access the potentially harmful linked content in a safe environment.

In some embodiments, in addition to or in lieu of providing the user 226 with a list of resources that are available to be accessed individually, as described above, the user 226 may instead be permitted to choose to access a streamlined feed of event notifications and/or available actions that may be taken with respect to events that are automatically detected with respect to one or more of the resources. This streamlined resource activity feed, which may be customized for each user 226, may allow users to monitor important activity involving all of their resources—SaaS applications, web applications, Windows applications, Linux applications, desktops, file repositories and/or file sharing systems, and other data through a single interface—without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 165 to notify a user 226 of something that requires the user's attention (e.g., approval of an expense report, new course available for registration, etc.).

FIG. 2C is a block diagram similar to that shown in FIG. 2B but in which the available resources (e.g., SaaS applications, web applications, Windows applications, Linux applications, desktops, file repositories and/or file sharing systems, and other data) are represented by a single box 228 labeled “systems of record,” and further in which several different services are included within the resource management services block 202. As explained below, the services shown in FIG. 2C may enable the provision of a streamlined resource activity feed and/or notification process for a client 165. In the example shown, in addition to the client interface service 216 discussed above, the illustrated services include a microapp service 230, a data integration provider service 232, a credential wallet service 234, an active data cache service 236, an analytics service 238, and a notification service 240. In various embodiments, the services shown in FIG. 2C may be employed either in addition to or instead of the different services shown in FIG. 2B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 224 without having to launch the native application. The system shown in FIG. 2C may, for example, aggregate relevant notifications, tasks, and insights, and thereby give the user 226 a dynamic productivity tool. In some embodiments, the resource activity feed may be intelligently populated by utilizing machine learning and artificial intelligence (AI) algorithms. Further, in some implementations, microapps may be configured within the cloud computing environment 214, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 2C, the systems of record 228 may represent the applications and/or other resources the resource management services 202 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 202, and in particular the data integration provider service 232, may, for example, support REST API, JSON, OData-JSON, and 6ML. As explained in more detail below, the data integration provider service 232 may also write back to the systems of record, for example, using OAuth2 or a service account.

In some embodiments, the microapp service 230 may be a single-tenant service responsible for creating the microapps. The microapp service 230 may send raw events, pulled from the systems of record 228, to the analytics service 238 for processing. The microapp service may, for example, periodically pull active data from the systems of record 228.

In some embodiments, the active data cache service 236 may be single-tenant and may store all configuration information and microapp data. It may, for example, utilize a per-tenant database encryption key and per-tenant database credentials.

In some embodiments, the credential wallet service 234 may store encrypted service credentials for the systems of record 228 and user OAuth2 tokens.

In some embodiments, the data integration provider service 232 may interact with the systems of record 228 to decrypt end-user credentials and write back actions to the systems of record 228 under the identity of the end-user. The write-back actions may, for example, utilize a user's actual account to ensure all actions performed are compliant with data policies of the application or other resource being interacted with.

In some embodiments, the analytics service 238 may process the raw events received from the microapps service 230 to create targeted scored notifications and send such notifications to the notification service 240.

Finally, in some embodiments, the notification service 240 may process any notifications it receives from the analytics service 238. In some implementations, the notification service 240 may store the notifications in a database to be later served in a notification feed. In other embodiments, the notification service 240 may additionally or alternatively send the notifications out immediately to the client 165 as a push notification to the user 226.

In some embodiments, a process for synchronizing with the systems of record 228 and generating notifications may operate as follows. The microapp service 230 may retrieve encrypted service account credentials for the systems of record 228 from the credential wallet service 234 and request a sync with the data integration provider service 232. The data integration provider service 232 may then decrypt the service account credentials and use those credentials to retrieve data from the systems of record 228. The data integration provider service 232 may then stream the retrieved data to the microapp service 230. The microapp service 230 may store the received systems of record data in the active data cache service 236 and also send raw events to the analytics service 238. The analytics service 238 may create targeted scored notifications and send such notifications to the notification service 240. The notification service 240 may store the notifications in a database to be later served in a notification feed and/or may send the notifications out immediately to the client 165 as a push notification to the user 226.

In some embodiments, a process for processing a user-initiated action via a microapp may operate as follows. The client 165 may receive data from the microapp service 230 (via the client interface service 216) to render information corresponding to the microapp. The microapp service 230 may receive data from the active data cache service 236 to support that rendering. The user 226 may invoke an action from the microapp, causing the resource access application 224 to send that action to the microapp service 230 (via the client interface service 216). The microapp service 230 may then retrieve from the credential wallet service 234 an encrypted OAuth2 token for the system of record for which the action is to be invoked, and may send the action to the data integration provider service 232 together with the encrypted OAuth2 token. The data integration provider service 232 may then decrypt the OAuth2 token and write the action to the appropriate system of record under the identity of the user 226. The data integration provider service 232 may then read back changed data from the written-to system of record and send that changed data to the microapp service 230. The microapp service 232 may then update the active data cache service 236 with the updated data and cause a message to be sent to the resource access application 224 (via the client interface service 216) notifying the user 226 that the action was successfully completed.

In some embodiments, in addition to or in lieu of the functionality described above, the resource management services 202 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 202 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 202 may, for example, parse these requests and respond because they are integrated with multiple systems on the back end. In some embodiments, users may be able to interact with the virtual assistance through either the resource access application 224 or directly from another resource, such as Microsoft Teams. This feature may allow employees to work efficiently, stay organized, and delivered only the specific information they are looking for.

### C. Systems and Methods for Detecting and Predicting Virtual CPU Resource Starvation of a Virtual Machine

A host system (e.g., a server) can host various virtual machines (VMs) configured to perform tasks, such as periodic tasks. However, certain host systems may experience resource starvation due to resource consumption of the VMs, which can cause momentary or periodic resource spikes affecting, for instance, scheduling of virtual central processing units (vCPUs) or interrupt execution time. Resource starvation can refer to the host being unable to support a virtual machine with the available computer resources. The delay in scheduling the interrupt can impact active workload on the vCPU leading to issues, such as failover, packet processing delays, protocol timer expiry, etc., causing connection loss or downtime. Further, it can be difficult to determine the source of the performance impact under an environment where a cloud service provider manages the host systems due to the lack of data associated with the status of the host system.

The systems and methods discussed herein can detect occurrences of vCPU scheduling delays (e.g., due to resource starvation) of VMs to predict and perform actions (e.g., healing actions) in advance. The systems and methods can detect vCPU resource starvation. For example, vCPU a timer device (e.g., physical or virtual) can be associated with individual vCPUs to generate timer interrupts for the respective vCPU. The vCPU timer interrupt can generate periodic timer interrupt or rely on a timer wheel or idle status to schedule a subsequent interrupt. Without a physical CPU (pCPU) resource crunch, the timer interrupt can be scheduled and fired by the vCPU at an expected time. With a pCPU resource crunch, the scheduling of the timer interrupt can be delayed, thereby delaying the firing time of the timer interrupt. The systems and methods can calculate the delta (or difference) between the expected and actual firing time of the timer interrupts. The systems and methods can initiate an application-specific corrective action, such as adjusting application or protocol timers, notifying the users or the administrator, etc.

The systems and methods can perform a prediction of vCPU resource starvation. For example, the systems and methods can obtain the historical data of the host system. The historical data can include at least resource consumption statistics associated with the vCPUs or occurrences of the timer interrupt delays. The systems and methods can map the occurrences of the delays against a time (e.g., a day, a week, etc.). The systems and methods can generate a plot to determine one or more future occurrences of timer interrupt delays. In some cases, the systems and methods can provide the historical data as input into a machine learning engine, such as to predict outages or scheduling latency and one or more actions to address the resource starvation. Hence, the systems and methods can detect and use the data associated with the history of resource starvation to predict subsequent occurrences of scheduling latency.

The systems and methods can perform one or more actions to manage the workload of the VMs. For example, the systems and methods can initiate an action to mitigate timer interrupt latency based on the historical data of the host system and tolerance level associated with the vCPUs or applications executing on the vCPUs. In some cases, the systems and methods can migrate the workload from one VM to another VM on the same host system without the timer interrupt latency. In some cases, the systems and methods can migrate the VM to another host system without timer interrupt latency. In some other cases, the systems and methods can spawn a new VM on a different host system to rebalance the traffic from the user. In another example, the systems and methods can adjust the receive queue of the network interface based on the threshold breaches indicated by the live data. In yet another example, for an application with high tolerance level, the systems and methods can determine to wait for a subsequent timeout before declaring an application timeout based on a timer interrupt delay.

Further, due to the latency in scheduling and firing the timer interrupt, it may be difficult to maintain existing connections of an application executing on the vCPU. For instance, the vCPU may experience protocol re-convergence or re-negotiation of the protocol, which can impact the existing connections of an application executing on the vCPU. The cost for handling protocol re-convergence can be higher than dropping and retransmitting data packets.

The systems and methods discussed herein can prioritize network protocol control packets on a network host bus adapter. Various host bus adapters may be presented to the VM providing the underlying network or storage functionality for the VM. The host bus adapter can support the transmit or receive (Tx/Rx) descriptor ring or command/completion ring. The Tx/Rx descriptor ring or the command/completion ring can be mapped to a virtual address space of the user or the kernel address space based on the device driver mode associated with the VM. Scheduling latency observed on the vCPU can indicate a large number of packets filling the receive ring or dropping from the receive ring (e.g., data or protocol control packets). In an illustrative example, dropping the protocol control packet can impact a session such as the border gateway protocol (BGP) session, thereby impacting the traffic flows from the BGP to the VM.

Hence, the systems and methods can mitigate protocol control packet drop by prioritizing the protocol control packet. For example, the systems and methods can transmit any protocol control packet in a transmit queue during scheduling latency. In another example, the systems and methods can prioritize the control packets in the receive ring or queue, such that the protocol stack can process the protocol packets before the data packets. In yet another example, the systems and methods can scan individual packets in the receive ring to determine and process the control packets. The systems and methods can reset the queue of the data packet to be processed after the control packet, for example. Hence, the systems and methods can prioritize impending protocol timeout or expiry to prevent connection loss, downtime, or protocol re-convergence.

Thus, by detecting and predicting resource starvation, the systems and methods described herein can at least mitigate resource starvation impact on VMs or vCPUs, thereby increasing the performance and reliability of the VMs. Further, by taking an action based on the historical data, such as migrating workload or VMs or prioritizing protocol control packets over data packets, the systems and methods can reduce delays of scheduling one or more vCPUs, decrease packet drop rate, improve the reliability of the VM, increase the efficiency of packet processing on various vCPUs, and improve user experiences using the VMs.

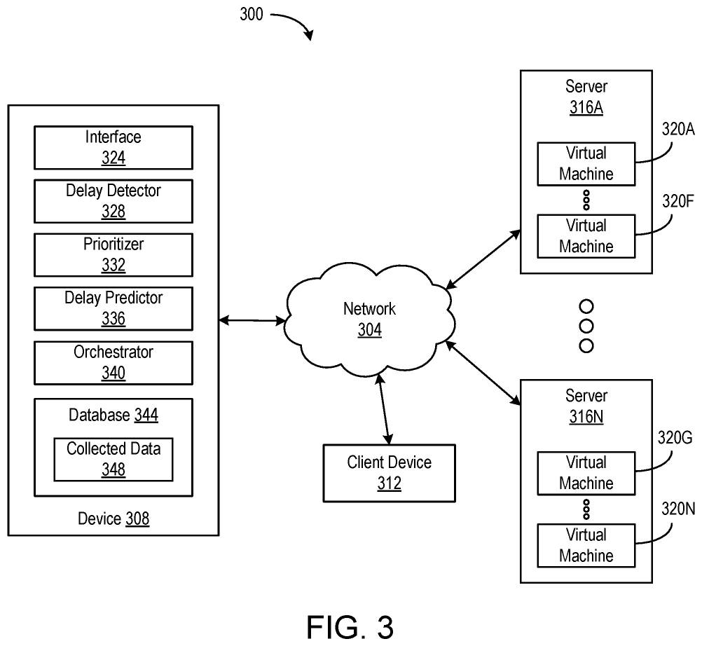

Referring to FIG. 3, depicted is a block diagram of one embodiment of a system 300 for detecting and predicting virtual CPU resource starvation of a virtual machine. The system 300 can include at least one network 304, at least one device 308, at least one client device 312, and one or more servers 316A-N (sometimes generally referred to as server(s) 316). The components of the system 300 can include or be composed of hardware, software, or a combination of hardware and software components. The components (e.g., network 304, device 308, client device 312, or server 316) of the system 300 can include or be composed of hardware, software, or a combination of hardware and software components. The one or more components (e.g., device 308, client device 312, or server 316) of the system 300 can establish communication channels or transfer data via the network 304. For example, the client device 312 can communicate with at least one of the device 308 or the server 316 via the network 304. In another example, the device 308 can communicate with other devices, such as the client device 312 or the server 316 via the network 304. The communication channel between various different network devices can communicate with each other via the network 304 or different networks 304.

The network 304 can include computer networks such as the Internet, local, wide, metro or other area networks, intranets, satellite networks, other computer networks such as voice or data mobile phone communication networks, and combinations thereof. The network 304 may be any form of computer network that can relay information between the one or more components of the system 300. The network 304 can relay information between client devices 312 and one or more information sources, such as web servers or external databases, amongst others. In some implementations, the network 304 may include the Internet and/or other types of data networks, such as a local area network (LAN), a wide area network (WAN), a cellular network, a satellite network, or other types of data networks. The network 304 may also include any number of computing devices (e.g., computers, servers, routers, network switches, etc.) that are configured to receive and/or transmit data within the network 304. The network 304 may further include any number of hardwired and/or wireless connections. Any or all of the computing devices described herein (e.g., client device 312, device 308, servers 316, etc.) may communicate wirelessly (e.g., via WiFi, cellular, radio, etc.) with a transceiver that is hardwired (e.g., via a fiber optic cable, a CAT5 cable, etc.) to other computing devices in the network 304. Any or all of the computing devices described herein (e.g., client device 312, device 308, servers 316, etc.) may also communicate wirelessly with the computing devices of the network 304 via a proxy device (e.g., a router, network switch, or gateway). In some implementations, the network 304 can be similar to or can include the network 170 or a computer network accessible to the computer 100 described herein above in conjunction with FIG. 1A or 1B.

The system 300 can include or interface with at least one client device 312 (or various client devices 312). Client device 312 can include at least one processor and a memory, e.g., a processing circuit. The client device 312 can include various hardware or software components, or a combination of both hardware and software components. The client devices 312 can be constructed with hardware or software components and can include features and functionalities similar to the client devices 165 described hereinabove in conjunction with FIGS. 1A-B. For example, the client devices 165 can include, but is not limited to, a television device, a mobile device, smart phone, personal computer, a laptop, a gaming device, a kiosk, or any other type of computing device.

The client device 312 can include at least one interface for establishing a connection to the network 304. The client device 312 can communicate with other components of the system 300 via the network 304, such as the device 308 or the servers 316. For example, the client device 312 can communicate data packets with one or more servers 316 via the network 304. The client device 312 can communicate with the device 308 via the network 304. The client device 312 can transmit data packets to the device 308 configured to select and forward the data packets from the client device 312 to at least one server 316. In some cases, the client device 312 can communicate with other client devices.

The client device 312 can include, store, execute, or maintain various application programming interfaces (“APIs”) in the memory (e.g., local to the client device 312). The APIs can include or be any types of API, such as Web APIs (e.g., open APIs, Partner APIs, Internal APIs, or composite APIs), web server APIs (e.g., Simple Object Access Protocol (“SOAP”), XML-RPC (“Remote Procedure Call”), JSON-RPC, Representational State Transfer (“REST”)), among other types of APIs or protocol described hereinabove in conjunction with clients 165 of FIG. 1B. The client device 312 can use at least one of various protocols for transmitting data to the server 316. The protocol can include at least a transmission control protocol (“TCP”), a user datagram protocol (“UDP”), or an internet control message protocol (“ICMP”). The data can include a message, a content, a request, or otherwise information to be transmitted from the client device 312 to a server 316. The client device 312 can establish a communication channel or a communication session with a server 316 and transmit data to the server 316. The client device 312 can establish a communication session or channel with the server 316 via the network 304 or other intermediary devices. In some cases, the client device 312 can transmit data to the server 316 to be forwarded or relayed to the device 308. In some other cases, the client device 312 can transmit data directly to the device 308. In some cases, data from the client device 312 to the server 316 can be intercepted by the device 308.

The client device 312 can be assigned a machine (e.g., at least one virtual machine 320) executing or hosted on the server 316 to establish a session. The machine can host one or more sessions for different client devices 312 or users. In some cases, the machine can be a multi-session machine, hosting multiple sessions for respective users. In some other cases, the machine can be a single session machine, hosting a session for individual client devices 312 or users. The client device 312 can access other types of machines hosted on the servers 316. For example, the client device 312 can provide or transmit credentials input by the user to launch a session or access a cloud service. Upon successful launch of the session, the client device 312 can access resources from the server 316, such as resources hosted by the machine or server 316 or resources communicated between the server 316 and other sources. The other sources can include cloud services, remote devices, data repositories, among others.

The system 300 can include or interface with one or more servers 316. The server 316 may be referred to as a host system or a cloud device. One or more of the servers 316 can include, be, or be referred to as a node, remote devices, remote entities, application servers, or backend server endpoints. The server 316 can be composed of hardware or software components, or a combination of both hardware or software components. The server 316 can include resources for executing one or more applications, such as SaaS applications, network applications, or other applications within a list of available resources maintained by the server 316. The server 316 can include one or more features or functionalities of at least resource management services (e.g., resource management services 202) or other components within the cloud computing environment (e.g., cloud computing environment 214), such as in conjunction with FIGS. 2A-C. The server 316 can communicate with the client device 312 via a communication channel established by the network 304, for example.

The server 316 can communicate data packets or traffic with at least the client device 312. The server 316 can serve or handle traffic from client devices 312. The server 316 can be associated with a server hash in a list of servers 316. In some cases, the server 316 can receive traffic from the device 308. In some cases, the server 316 can receive data from the client device 312 via the device 308. For instance, an intermediary device can perform a load balancing technique to distribute traffic from client devices 312 to one or more servers 316, thereby establishing a communication session or channel.

The server 316 can host, include, or execute one or more virtual machines (VM) 320A-N (sometimes generally referred to as VM(s) 320). The server 316 can correspond to or be referred to as a host system hosting the VMs in a virtualized environment. The server 316 can assign at least one VM 320 to individual client devices 312 or users. The VM 320 can be assigned to at least one user (e.g., multi-session machine or single session machine). The VM 320 can establish a session or a communication channel with the client device 312 via an application (e.g., a network application executing on the client device 312). For instance, upon successfully verifying the credentials of the user, the server 316 can establish a session between the client device 312 and one of the virtual machines 320 assigned to the user. The VM 320 can provide the client device 312 with access to applications (e.g., network applications), among other resources on the VM 320. Individual applications accessed through the VM 320 may consume different amounts of resources.

In further example, the server 316 can host a dedicated session (e.g., dedicated VM 320 on a server 316) assigned to a particular user or shared session (e.g., multiple VMs 320 on a server 316) where resources from a server 316 can be distributed to multiple sessions accessed by multiple client devices 312 or users. The server 316 can provide client devices 312 with access to resources via one or more sessions on one or more VM 320. The server 316 can provide the client device 312 with access to resources of remote services. For example, the resources can include at least virtual applications or virtual desktops (VAD). The server 316 can provide the resources upon a successful session launch or in response to the user accessing the VM 320. In some cases, the server 316 may correspond to one or more VM 320.

The server 316 can include a physical central processing unit (pCPU) or a shared CPU. The VM 320 hosted by the server 316 can include a virtual CPU (vCPU). Individual VMs 320 can include independent vCPU. The pCPU can share, provide, or distribute resources to one or more vCPUs of individual VMs 320 hosted on the server 316. The server 316 may distribute an equal amount of resources between the VMs 320. In some cases, the server 316 may distribute varying amounts of resources between the VMs 320. For instance, a first VM (e.g., first vCPU) may be allocated 30% of the pCPU, a second VM (e.g., second vCPU) may be allocated 25% of the pCPU resources, and other VMs may be allocated with the remaining amount of resources.

The resource distribution between different VMs may be based on the user account, such that higher priority users may be allocated or provided with more resources. In some cases, the server 316 can distribute resources based on historical actions or data indicating users' consumption of resources. In this case, the server 316 may assign a VM 320 with more allocated resources to users that consume more resources and another VM 320 with lower allocated resources to users that do not consume as many resources, for example. In some other cases, the resource distribution between various VMs 320 may be random (e.g., randomly assign resources to individual VMs 320). The server 316 can initiate other processes or operations to distribute resources to the VMs 320.

The server 316 can manage the VMs 320 hosted on the server 316. In some cases, the server 316 can receive instructions from a remote device (e.g., device 308) to perform an operation for managing the VMs 320. For example, the server 316 can generate one or more new VMs 320. The server 316 can modify existing VMs 320, such as assigning the generated VMs 320 to individual users. The server 316 can reallocate resources to the VMs 320. The server 316 can remove or terminate a VM 320 or a session established between the VM 320 and a client device 312. The server 316 can transfer or migrate workload of a session (e.g., migrating a session) from a VM 320 to another VM 320. For example, the server 316 can migrate a workload from VM 320A to VM 320B in the same server 316 (e.g., server 316A). In another example, the server 316 can migrate a workload from the VM 320A to VM 320G in a different server 316 (e.g., server 316B). In some cases, the server 316 can generate or spawn a new VM 320 on a different host (e.g., a different host system or a different server 316C). Hence, the server 316 can receive instructions to manage or rebalance the traffic going to different VMs 320.

The server 316 can record logs of data associated with historical actions (e.g., history of actions) of the VMs 320 or the users using the VMs 320. The server 316 can process the data locally (e.g., on-premise) or transmit the data for processing by the device 308 (or other remote devices). For instance, the server 316 can record operations initiated or executed by the different VMs 320 or other historical data associated with the VMs 320. The historical data can include at least application accessed, CPU utilization, resource spikes, timer interrupt scheduling, execution of timer interrupts, among others. For example, the server 316 can record resource starvation or resource spikes, which may affect the timing in the scheduling of timer interrupts or in initiating the timer interrupt to perform a task. The server 316 can send the historical data to the device 308 to determine an action to mitigate or prevent delays of the timer interrupts. In some cases, the server 316 can perform one or more features or functionalities of the device 308, such as executing local or on-premise operations to analyze the data and determine an action.

The VM 320 can include a timer device associated with the vCPU. The timer device can be a physical timer device or a virtual timer device. The timer device can generate a vCPU timer interrupt for the respective vCPU. In some cases, the VM 320 can use the timer device to initiate scheduling of a timer interrupt based on a time indicated by the timer device. The granularity of the timer interrupt may be referred to as time tick or jiffies. The frequency of the timer interrupt can be configured during an Operating System (OS) boot time or run time. For instance, parameters (e.g., frequency, granularity, scheduling, etc.) of the timer interrupt may be configured by the administrator of the server 316 or VM 320. Based on at least the granularity or the frequency of the timer interrupt, the time associated with a time tick can be calculated. For example, for a frequency value of 1000 Hz, 1 tick can correspond to 1 millisecond (ms) for the granularity of the timer interrupt.

The VM 320 can be programmed or configured by the OS of the server 316. For example, the vCPU timer interrupt of the VM 320 can be programmed by the OS to generate a periodic interrupt. The periodic interrupt can be referred to as a periodic timer. In some cases, the VM 320 can rely on the timer wheel (e.g., ring buffer of linked list of events) or idle status of the vCPU scheduler. For example, the server 316 can detect that the vCPU of the VM 320 is idled. In response to the detection, the server 316 can generate or program the timer interrupt at a subsequent tick or jiffy, which may be referred to as a tickle timer. Accordingly, the VM 320 can schedule a timer interrupt based on at least one of the periodic timer or the tickle timer. The scheduled time for initiating the timer interrupt may be associated with an expected time for initiating the timer interrupt.

The server 316 can schedule the timer interrupt for the vCPU of the VM 320 based on the resource available on the pCPU. For example, without resource crunch, the pCPU can schedule a timer interrupt for the vCPU, which can be initiated without delay (e.g., timer interrupt fired at expected periodicity or time tick). In some cases, due to resource crunch on the pCPU, the pCPU may experience latency in scheduling the vCPU on the pCPU. In response to the delayed scheduling, the timer interrupt may not initiate (e.g., by the pCPU or the vCPU) at an expected time. In some other cases, resource crunch on the pCPU can cause latency in firing the timer interrupt regardless of scheduling latency, for example. Hence, the server 316 can provide data associated with the timer interrupt to the device 308 (e.g., remote or local to the server 316) to determine resource starvation of the pCPU. For example, the server 316 can provide at least a first time indicating the expected firing time of the timer interrupt and a second time indicating the firing time (e.g., actual firing time) of the timer interrupt. The server 316 can provide other historical or live data of at least the pCPU, the VMs 320, or the vCPU of the VMs 320 to the device 308.

In some cases, the VM 320 can include, be associated with, or be presented with network host bus adapters (sometimes generally referred to as bus adapter(s)). The bus adapter can be presented to the VM 320 in one of emulated mode, para-virtualized mode, shared mode, or dedicated mode. The bus adapter can provide an underlying network functionality or storage functionality to the VM 320. The bus adapter can support one or more Tx/Rx descriptor ring (e.g., sometimes referred to as Tx/Rx ring buffer or Tx/Rx queue). The Tx/Rx descriptor can include or be associated with a command/completion ring.

The Tx/Rx ring can be linked or tied to the vCPU, such as in the user space or the kernel. For example, in the user space, the Tx/Rx ring can be used for polling and processing packets. In the kernel space, the Tx/Rx ring can be used for interrupt handling or processing packets. The network adapter can map the Tx/Rx ring to the virtual address of the user address (e.g., for the poll-mode driver) or to the kernel address space (e.g., for kernel-mode driver) within the VM 320. For example, the Tx/Rx ring can be bound to the user space process. In some cases, the Tx/Rx ring can be bound to the kernel thread. The Tx/Rx ring can operate independently of other Tx/Rx rings of the VM 320. The Tx/Rx ring can receive packets, such as network data packets or protocol control packets. The packets can be analyzed by the device 308.

The device 308 can include various components to determine the performance of machines hosted by the server 316 and providing a list of machines to perform one or more actions. The device 308 can include at least one interface 324, at least one delay detector 328, at least one prioritizer 332, at least one delay predictor 336, at least one orchestrator 340, and at least one database 344. The database 344 can include at least one collected data storage 348. The collected data storage 348 may be referred to as a historical data storage. Individual components (e.g., interface 324, delay detector 328, prioritizer 332, delay predictor 336, orchestrator 340, or database 344) of the device 308 can be composed of hardware, software, or a combination of hardware and software components. Individual components of the device 308 can be in electrical communication with each other. For instance, the interface 324 can exchange data or communicate with the delay detector 328, prioritizer 332, delay predictor 336, orchestrator 340, or database 344. The one or more components (e.g., interface 324, delay detector 328, prioritizer 332, delay predictor 336, orchestrator 340, or database 344) of the device 308 can be used to perform features or functionalities, such as detecting resource starvation, detecting latency in scheduling or initiating timer interrupt, prioritizing certain packets, predicting timer interrupt latency, or orchestrating actions to mitigate protocol packet drop or latency of timer interrupt. The device 308 can operate remotely from the servers 316 or other devices in the system 300. In some cases, the device 308 can be a part of the server 316, such as an integrated device, embedded device, a server-operated device, or a device accessible by the administrator of one or more servers 316 hosting one or more VMs 320. For example, the device 308 can perform operations local or on-premise to the server 316.

The interface 324 can interface with the network 304, devices within the system 300 (e.g., client devices 312 or servers 316), or components of the device 308. The interface 324 can include features and functionalities similar to the communication interface 115 to interface with the aforementioned components, such as in conjunction with FIG. 1A. For example, the interface 324 can include standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The interface 324 can include at least a built-in network adapter, network interface card, PCMCIA network card, EXPRESSCARD network card, card bus network adapter, wireless network adapter, USB network adapter, modem, or any other device suitable for interfacing one or more devices within the system 300 to any type of network capable of communication. The interface 324 can communicate with one or more aforementioned components to receive data from at least one of the client devices 312 or the servers 316 (e.g., live data or historical data), such as data associated with the pCPU of the server 316, vCPU of the VM 320, or traffic received by the VMs 320.

The delay detector 328 can detect the latency of scheduling vCPU or firing the timer interrupt scheduled by the server 316. The delay detector 328 can receive, obtain, or retrieve data associated with the timer interrupt scheduled by the pCPU for the VMs 320. The data can include or correspond to historical data or live data. In some cases, the live data can refer to data received and processed by the one or more components of the device 308 in response to the collection of the data by the server 316. In this case, the historical data can refer to data retrieved by one or more components of the device 308 for processing at a subsequent time period (e.g., 1 second, 10 minutes, etc. after receiving and storing the data). In some other cases, the live data can correspond to or be the same as the historical data. For example, the delay detector 328 can obtain the vCPU scheduling time and the initiation time of the timer interrupt by the vCPU of the VM 320.

The delay detector 328 can calculate the delta or the differences between the expected timer interrupt time (e.g., tick or jiffy) and the actual timer interrupt initiation. The expected timer interrupt time (e.g., expected time) can refer to the time scheduled by the pCPU to initiate or fire the timer interrupt. The actual timer interrupts time (e.g., actual time or initiation time) can refer to the time that the timer interrupt fires. By calculating the delta between the expected time and the actual time, the delay detector 328 can determine the ticks, latency, or delay of the vCPU run-time or execution time of the vCPU.

The latency for initiating the vCPU can be associated with the availability of the resources of the pCPU. For example, with minimal or no resource starvation, the delta between the expected time and the actual time may be zero or a low value (e.g., below a threshold). In another example, with resource starvation, the delta can be above the threshold. Hence, high latency for executing the timer interrupt can indicate resource starvation.

The delay detector 328 can determine, obtain, or identify the threshold of the delta. The threshold of the delta can include or be referred to as a delta threshold, time threshold, latency threshold, or delay threshold. For example, the threshold can be configured to 200 ms, 1 second, etc. The threshold can be set by the administrator or the OS of the server 316. The threshold can be set independently for different applications executing on the VMs 320 (e.g., OS of the respective VM 320). For instance, the OS can set a first threshold for a first application, a second threshold for a second application, and a third threshold for a third application. The predetermined threshold may be different based on the application executing on the VM 320.

In some cases, the delay detector 328 can configure, set, adjust, or modify the threshold associated with individual applications executing on the VM 320. For example, the delay detector 328 can monitor the traffic associated with an application during a period of time (e.g., day, week, month, etc.). The traffic can be from one or more client devices 312 accessing the assigned VMs 320. The delay detector 328 can gauge or determine traffic received by the application. For example, the delay detector 328 can determine the volume of traffic for the application based on at least one of the day or the time of day. The delay detector 328 can adjust the delay threshold of the application based on at least one of the volume of traffic, the day, or the time of day. For instance, the delay detector 328 may increase the threshold during high traffic (e.g., increasing tolerance to latency) and decrease the threshold during low traffic. Hence, the delay detector 328 can set different thresholds for different applications.

In some cases, the delay detector 328 can configure different thresholds for different users. For example, the delay detector 328 can monitor and determine that a first user (or client device 312) consumes higher bandwidth using the application than a second user. The delay detector 328 can increase the threshold associated with the application executing for the first user or decrease the threshold associated with the application executing for the second user.

In some cases, the delay detector 328 can determine or obtain a tolerance level associated with the users or the applications executing on the VM 320. For example, the delay detector 328 can set a higher threshold for users or applications with a higher latency tolerance level. In another example, the delay detector 328 can set a lower threshold (or normal threshold) for users or applications with a lower latency tolerance level. The delay detector 328 or the OS can obtain or be configured with other parameters to configure the latency threshold associated with the application or the user. The latency can be monitored at least periodically by the VM 320 or one or more components of the device 308, such as to initiate a process or an action (e.g., corrective action).

The delay detector 328 can determine, with a timer period (e.g., hours of the day, day of the week, etc.), a count of the number of delays in occurrences of a timer interrupt scheduled for the vCPU of a VM 320 executing an application. The count can include or correspond to a counter of timer interrupt latency occurrences, where the latency is greater than the threshold configured for the application. The latency can be configured based on the timer period. For example, in response to detecting a scheduling latency of the vCPU for an executing application, the delay detector 328 can increase the count of occurrences of the delay.

The delay detector 328 can compare the count with a threshold established or configured for the time period. In this case, the threshold can refer to a count threshold, a counter threshold, or an occurrence threshold. The count threshold can be configured similarly to the latency threshold. For example, based on at least one of the application executing on the VM 320, user using the application, time period, or tolerance to latency, the delay detector 328 or the OS of the server 316 can configure the count threshold accordingly. In further example, the delay detector 328 can increase the count threshold to be more tolerant to latency and decrease the count threshold to be less tolerant to latency. For example, the count threshold can be configured to 5, 10, 20, 35, etc. for a time period (e.g., a minute, 30 minutes, an hour, etc.).

In some cases, the delay detector 328 can determine the threshold (e.g., latency threshold or count threshold) based on a model. The model can be trained by a machine learning engine. For example, the delay detector 328 can input historical performance data associated with one or more vCPUs of the one or more VMs 320 hosted by the server 316 to the machine learning engine. The historical performance data can be a part of the historical data, such as the historical data of the server 316. The machine learning engine can train the model using the historical performance data. Based on the model, the delay detector 328 can identify patterns of latency occurrences associated with the time period (e.g., hours, days, weeks, etc.) for applications executing on the VMs 320. Based on at least the latency occurrences at the time period or the tolerance level of the user, the application, or the VM 320, the delay detector 328 configure the latency threshold or count threshold to be more or less tolerant to vCPU scheduling latency.

In some cases, the delay detector 328 can determine that a count of the number of delay occurrences within the time period is below a count threshold. For example, the delay detector 328 can identify one or more VMs 320 hosted by the server 316. The delay detector 328 can determine that the second count of a number of delays within the time period in occurrences on the one or more VMs 320 is below the count threshold. The delay detector 328 can record or store a list of VMs 320 having a count below the count threshold (or above the count threshold) in the database 344. The delay detector 328 can analyze or monitor occurrences of the vCPU scheduling latency on servers 316 (or host systems). The data for the number of

The prioritizer 332 can prioritize one or more packets received in the queue or buffer (e.g., Rx ring) of the host bus adapter (or bus adapter). The prioritizer 332 can instruct the bus adapter to perform one or more features or functionalities to prioritize the protocol control packets (e.g., the transmission or reception of the control packets). For example, based on detecting vCPU scheduling latency, the prioritizer 332 may determine that the Rx ring is overflowing or high incoming traffic for a populated Rx ring. Due to a filled Rx ring, one or more packets incoming to the Rx ring may be dropped by the vCPU. Hence, the prioritizer 332 can perform a logic to handle incoming packets during a time period of scheduling latency, such as prioritizing certain packets over others.

For example, the prioritizer 332 can identify any protocol control packet in a transmit queue of the VM 320. If the protocol control packet is not transmitted during or due to scheduling latency, the prioritizer 332 can transmit the protocol control packet in response to the identification of the protocol control packet or the detection of the scheduling latency. In this case, the prioritizer 332 can transmit the protocol control packet immediately (e.g., within a short period of time or the next tick) upon detection of the scheduling latency. The prioritizer 332 transmitting the packet can include or correspond to instructing the bus adapter to transmit the packet. For example, the prioritizer 332 can instruct the bus adapter to transmit protocol control packets for the VM 320 in response to the count of the number of delays greater than or equal to the count threshold or before transmission of the data packets.

In some cases, the Rx ring may be dedicated to control packets (e.g., protocol control packets). The prioritizer 332 can detect control packets in the Rx ring that has not been processed (e.g., outstanding control packets in the Rx ring). For example, the prioritizer 332 can detect at least one control packet in the Rx ring during a time period where the count of delay occurrences is greater than or equal to a threshold. The prioritizer 332 can prioritize, increase queue position, or process the control packet in the Rx ring in response to detecting scheduling latency. The prioritizer 332 can process the control packets before data packets. The prioritizer 332 can configure the priority, ranking, or score of individual types of packets based on a configuration by the administrator of the server 316. For instance, the prioritizer 332 can prioritize control packets over data packets. In other instances, the prioritizer 332 can prioritize certain types of packets over at least one of the control packets or data packets.

In some cases, the packets may not provide an indication of a type, such as whether the packet is a data packet or a control packet. In this case, the prioritizer 332 can analyze or scan the packets in the Rx ring to determine whether individual packets are control packet(s) or data packet(s). In response to detecting one or more control packets, the prioritizer 332 can process the control packet for the VM 320. For instance, the prioritizer 332 can rearrange the queue, such that one or more control packets can be processed in the next tick. Further, the prioritizer 332 can rearrange the queue, such that data packets are reset to the back of the queue or after control packets, for example. The prioritizer 332 processing the packet can include or correspond to instructing the bus adapter to process the packet. Hence, the prioritizer 332 can prioritize any impending protocol timeout or expiry.

In some cases, the prioritizer 332 can configure the queue of the bus adapter. For instance, the prioritizer 332 can transmit an instruction to the bus adapter to configure the queue depth. Based on an indication of scheduling latency, or a time period indicating scheduling latency or resource starvation, the prioritizer 332 can increase the depth (e.g., size, length, or space) of the queue, such as the Rx queue or the Tx queue. Increasing the queue depth can reduce the number of packet drops due to the lack of an unallocated queue slot, for example. Subsequent to the time period of scheduling delay, the prioritizer 332 may decrease the queue depth to an original queue depth. In some cases, the prioritizer 332 may maintain the queue depth for a subsequent time period, such as the next time period with scheduling latency or high traffic.

The delay predictor 336 can perform a prediction or determine a scheduling latency or a timer interrupt latency at a future time period. For example, the delay predictor 336 can determine or predict the count of the number of delays for the future time period. The delay predictor 336 can perform the prediction based on the historical data, such as historical timer interrupt data. The delay predictor 336 can use a model trained by a machine learning engine to predict the occurrences of scheduling latency. The machine learning engine can train any types of model, such as Holt-Winters, Box Plot, Autoregressive Integrated Moving Average (AMNIA), among others. The delay predictor 336 can predict outages of one or more VMs 320 or servers 316. In some cases, the delay predictor 336 can use the model to determine the upper bound and lower bound for the scheduling latency to perform a reactive action or process, thereby avoiding connection loss, downtime, or re-convergence.

For example, the delay predictor 336 can provide the historical data as input to the machine learning engine. The machine learning engine can train a model based on the historical data. For instance, the historical data can include at least the time period (e.g., the time of day, the day of the week, etc.), the count of latency occurrences during the time period, the application executing on the VM 320 consuming the resources, and the user using the VM 320. The delay predictor 336 can use the model trained with the historical data to determine to generate a plot or other metrics. The plot can include at least a time of day or week, the number of latency occurrences, and the number of threshold breaches, such as the number of times the count of the occurrences equals to or exceeds the threshold.

The delay predictor 336 can increase the depth of the plot, array, or prediction based on the granularity of the data from the VMs 320 of the servers 316. For example, the delay predictor 336 can provide a plot indicating hourly threshold breach(es) for individual VMs 320. With greater granularity, the delay predictor 336 can provide a plot indicating threshold breaches every 10-minutes, for example. In further example, the delay predictor 336 can provide an array indicating a count of threshold breaches, a day, an hour, or the week of latency occurrences (e.g., Threshold breach[day][hour] or Threshold breach[week][day][hour]).

The delay predictor 336 can perform a lookup of the prediction plot or array. The delay predictor 336 can store and update the prediction in the database 344. In some cases, the delay predictor 336 can periodically train or update the model to enhance the prediction, such as every day, week, bi-weekly, etc. In some cases, the delay predictor 336 can obtain the prediction daily for determining scheduling latency occurrences on a subsequent day (e.g., the next day or other time periods). In some cases, the delay predictor 336 can notify the administrator of the server 316 to provide or indicate an instruction or process in response to the scheduling latency. In some cases, the delay predictor 336 can provide the predictions to the orchestrator 340 to initiate one or more actions in response to the scheduling latency based on various parameters, such as time period, executed application, user, etc.

The orchestrator 340 can perform one or more instructions, actions, or processes for the server 316 or the VM 320 of the server 316. For instance, the orchestrator 340 can be a part of at least one of the servers 316 to perform the processes or tasks to manage the VM 320. In another example, the orchestrator 340 can be remote from the server 316. The orchestrator 340 can transmit instructions to the server 316, the VM 320, or the vCPU of the VM 320 to perform a process. The orchestrator 340 can include or may be referred to as a VM orchestrator, an instruction transmitter, or VM manager. The orchestrator 340 can use historical data processed by one or more components (e.g., delay detector 328, prioritizer 332, or delay predictor 336) of the device 308 to determine and execute one or more actions. For example, the orchestrator 340 can determine at least one occurrence of a scheduling latency (e.g., using data from the delay detector 328 or delay predictor 336). The orchestrator 340 can determine to perform an action prior to or during an event, such as prior to scheduling delay or resource starvation.

For example, the orchestrator 340 can receive a prediction from the delay predictor 336 indicating various time periods of scheduling delays (e.g., a count of delays greater than or equal to a count threshold). The orchestrator 340 can determine to perform a process before at least one time period of scheduling delays, such as 1 minute, 5 minutes, 10 minutes, 1 hour, or other time before the predicted time period. In some cases, the orchestrator 340 can perform the process in response to detecting that the count of occurrences of the scheduling latency reaches a count threshold. Accordingly, the orchestrator 340 can perform a process to mitigate the latency of scheduling or initiating timer interrupt (e.g., avoiding resource starvation) for the vCPU of the VM 320.

The orchestrator 340 can perform one or more processes or take different actions based on at least the configuration of the administrator of the server 316. For example, the orchestrator 340 can perform a process based on the tolerance level of the application executing on the VM 320. A low tolerance level can represent an application that is sensitive to scheduling delays. A medium or a high tolerance level can represent an application that is not so sensitive to scheduling delays. The tolerance level for applications (or VMs 320) may be determined, configured, or assigned by the administrator. Accordingly, the orchestrator 340 can execute a process based on the configuration of the tolerance level assigned to the application (or user).

In some cases, the orchestrator 340 can determine and assign the tolerance level to the application based on the traffic of the applications. For instance, applications receiving high traffic may be configured with a high tolerance level, and applications with low traffic may be configured with a low tolerance level. In another example, applications with high traffic may be configured with a low tolerance level, and applications with low traffic may be configured with a high tolerance level. In some other cases, the orchestrator 340 can determine the tolerance level based on the user of the VM 320. For example, the administrator may configure the user to be a priority user (e.g., the preferred user or high-ranked user). In this case, the orchestrator 340 may lower the tolerance level for the VM 320, such that the prioritized user does not experience scheduling delays, for example.

The orchestrator 340 can perform the process to avoid resource starvation or scheduling delay for any tolerance level. With a low, medium, or high tolerance level, the orchestrator 340 can select and perform a first, second, or third process respectively to avoid scheduling latency. The individual processes to perform based on the tolerance level may be configured by the administrator. For instance, in certain servers 316, a low tolerance level can be associated with a first process and a high tolerance level can be associated with a third action. For certain other servers 316, the low tolerance level can be associated with a second process, and the high tolerance level can be associated with the first process, among other variations.

The process executed by the orchestrator 340 can include migrating the application to a different VM 320, such as from a first to a second VM. The migration process can be performed by the orchestrator 340 or instructed by the orchestrator 340 to the one or more servers 316 to perform the migration of at least the application or the VM 320, for example. The migration of the application may include or be referred to as a migration of the workload of a VM 320. The orchestrator 340 can migrate the application from a first VM to a second VM on the same server 316. The orchestrator 340 can select the second VM for migration based on historical data associated with the second VM. For instance, the orchestrator 340 can select the second VM where scheduling latency is not seen at least during the time period of scheduling latency on the first VM. In some cases, the orchestrator 340 can determine to migrate to a second VM that has not experienced scheduling latency, such as for a low tolerance level application. By migrating to a second VM, the second vCPU of the second VM can execute the application.

In some cases, the orchestrator 340 can execute a process to migrate the application to a second server (e.g., a second one or more processors or a second host system). For instance, the orchestrator 340 can determine that a second VM of a second server does not experience scheduling latency during the time period. In this case, the orchestrator 340 can determine to migrate the application to the second VM 320 on a different server 316. In some cases, the orchestrator 340 may consider or determine VM 320 of a different server 316 based on unavailable VMs 320 of the first server or the VMs 320 of the first server also experiencing the scheduling latency at or approximately near the time period.

In some cases, the orchestrator 340 can migrate the VM 320 from a first server to a second server. For example, the orchestrator 340 can determine that the pCPU of the first server hosting the VM 320 experiences resource starvation at a time period. The resource starvation of the pCPU may affect the vCPUs hosted on the first server. The orchestrator 340 can identify or determine a second server without resource starvation, at least at the time period. The orchestrator 340 can determine that the second server have resources to host the VM 320, such that hosting the VM 320 does not cause the resource starvation on the second server. Accordingly, the orchestrator 340 can migrate the VM 320 (e.g., session connection and all workload associated with the VM 320) to the second server from the first server.

In some cases, the orchestrator 340 can determine that the second server can host the application or the workload from the first server. The orchestrator 340 may not migrate the VM 320 from the first server to the second server. The orchestrator 340 can instruct the second server to launch or deploy a second VM, such as in response to the count of the number of delays exceeding the threshold. In some cases, the orchestrator 340 can launch the second VM for the second server. With the launched second VM, the orchestrator 340 can migrate the application from the VM 320 of the first server to the second VM on the second server. Therefore, the orchestrator 340 can rebalance the traffic from the client device 312 to one or more servers 316.

In some cases, the orchestrator 340 can adjust the number of packets being processed at the Rx queue of the bus adapter or network interface. For instance, during the time period of scheduling latency, the orchestrator 340 prioritize protocol control packets to be processed or transmitted before data packets. In this case, based on the magnitude of count threshold breaches for timer interrupt delays, the orchestrator 340 can prioritize a higher number of received protocol control packets to be processed or transmitted. Hence, the orchestrator 340 can avoid protocol timeout or connection loss due to protocol control packet drop.

In some cases, with a high tolerance level, the orchestrator 340 may provide a leeway or increase the wait time for executing the timeout, such as increasing the timeout time by 1 second, 10 seconds, 1 minute, etc. The orchestrator 340 may wait for the next timeout period before initiating the application timeout call indicating that the session is expired, for example. In some cases, the historical data of threshold breaches can be used to adjust the Rx ring size dynamically. For example, before the predicted scheduling latency occurrences (e.g., 1 minute, 30 seconds, 10 seconds before, etc.), the orchestrator 340 can adjust the Rx ring size dynamically in advance to enable more packets to be received, thereby dropping less incoming packets. The orchestrator 340 can shrink or lower the Rx ring size upon passing or completing the time period of the scheduling delay. The orchestrator 340 can perform ring size optimization features or functionalities to adjust the ring size or reconfigure the ring size to a normal size.

In some cases, the orchestrator 340 can use the historical data (or live data) of threshold breaches to adjust the queue depth of the packets being processed in the receive queue of the bus adapter. For example, in response to determining that the number of occurrences of the scheduling latency exceeds a count threshold, the orchestrator 340 can increase the depth of the Rx queue. The orchestrator 340 can prioritize control packets in the Rx queue. By prioritizing the packet, the orchestrator 340 can at least process or transmit the protocol packet before one or more data packets, such as to minimize protocol timeout. The orchestrator 340 can increase or decrease the queue size similar to the configuration of the ring size.

The database 344 can include, store, or maintain various data to detect scheduling latency, resource starvation, perform prediction of latency, determine the tolerance level of the application (or the VM 320 or the user), among other data. The database 344 can include collected data storage 348. The collected data storage 348 can include data collected from any devices interconnected via the network 304, such as data from the server 316 (e.g., host system), the VM 320 of the server 316, etc. The data from the server 316 can include at least pCPU data, an identifier of the respective server 316, or data associated with the VM 320. The data from the VM 320 can include at least the vCPU data, traffic (e.g., protocol control packet or network data packet), applications of the VM 320, user assigned to the VM 320, etc.

The collected data storage 348 can store data indicating the scheduling latency or delays of the timer interrupt scheduling or firing time. For example, the collected data storage 348 can store the time of scheduling the vCPU, the time period of executing the timer interrupt, or the time period expected for executing the timer interrupt. The collected data storage 348 can store the delta of the expected time and the actual time calculated by the delay detector 328. The collected data storage 348 can store the time period of the occurrences of the detected delays. The collected data storage 348 can store the count of the number of delays.

In some cases, the collected data storage 348 can store the threshold data, such as the latency threshold and count threshold. The collected data storage 348 or other portions of the database 344 can be accessed by an administrator of the device 308 or at least one of the servers 316. For example, the administrator can access and configure the threshold for at least the latency or the count of delays. The collected data storage 348 can store the tolerance policy for applications, users, VMs 320, servers 316, among others.

The collected data storage 348 can store the list of VMs 320 having a count below a count threshold at various time periods. For instance, the one or more components (e.g., delay detector 328, the orchestrator 340, etc.) of the device 308 can use the list of VMs 320 having a count below a threshold at a time period to determine or select at least a VM 320 or a server 316 to migrate the application or the VM 320. In some cases, the collected data storage 348 can store prediction data generated by the delay predictor 336 or a trained model. For example, the collected data storage 348 can store the plot indicating times of day, week, or month of occurrences of scheduling delays. In another example, the collected data storage 348 can store historical performance data of individual VMs 320 or servers 316. In some cases, the collected data storage 348 can store information associated with the application executing on the VM 320. The collected data storage 348 can store other data collected from any device or component of the system 300.

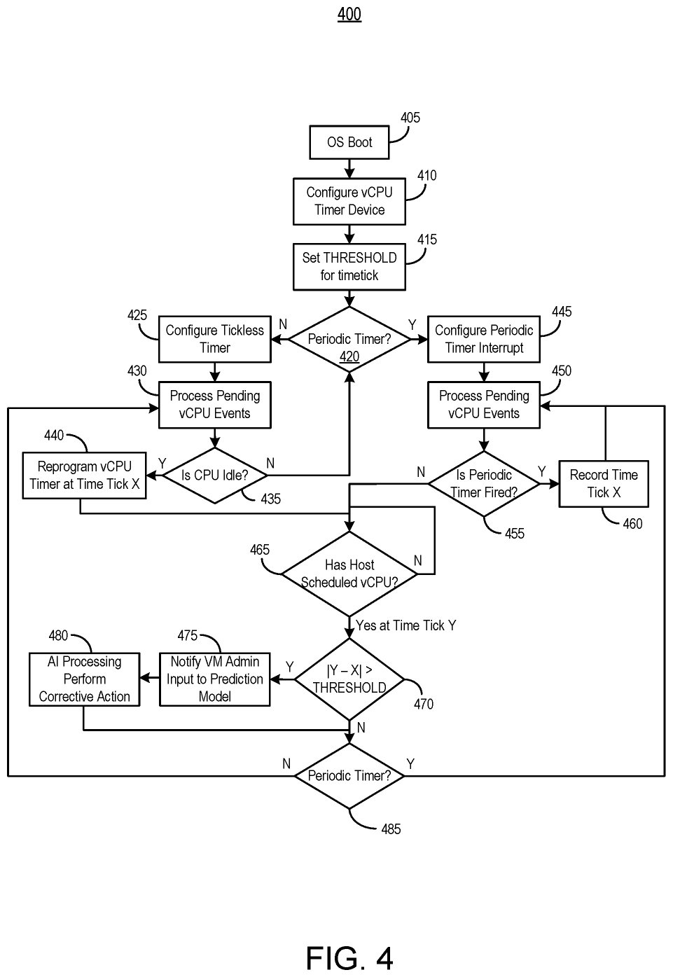

Referring to FIG. 4 is an example workflow diagram 400 for detecting and predicting vCPU resource starvation of a VM 320. The diagram 400 can include various operations for detecting resource starvation, such that the device 308 or the server 316 can perform a process to mitigate resource starvation or packet drop. The example diagram 400 can include operations, which can be executed, performed, or otherwise carried out by one or more components of the system 300 (e.g., device 308, server 316, etc.), the computer 101, the cloud computing environment 214, or any other computing devices described herein in conjunction with FIGS. 1A-2C. For example, the operations can be performed by the server 316 or the device 308 monitoring activities or receiving historical data from the server 316. In another example, the operations can be performed by the device 308 embedded as part of at least one server 316.

The server 316 can initiate or perform a boot-up or an OS boot (405). Upon an OS boot, the server 316 can configure a timer device for individual vCPUs of the VMs 320 (410). The server 316 can set a threshold for the time tick (415). The threshold for the time tick can refer to the time threshold or the latency threshold representing a delayed vCPU scheduling. The server 316 can determine whether the timer is configured as a periodic timer for the vCPU (420). The configuration of the timer device can be set by the administrator of the server 316 or the device 308. If the timer device is not configured as a periodic timer, the server 316 can configure a tickless timer (e.g., tickles timer) for the vCPU (425). The server 316 can configure the tickless timer to schedule a timer interrupt at a future time tick.

Upon configuring the tickless timer, the VM 320 can process the pending vCPU events (430). In response to the VM 320 processing the pending events, the server 316 can determine whether the vCPU of the VM 320 is idled (e.g., in an idled state or a waiting state). The server 316 can determine whether the vCPU is idle (435). In some cases, to determine whether the vCPU is idle can refer to or include determining whether to program the next timer interrupt at a future time tick. For instance, in response to determining that the vCPU is idle, the server 316 can reprogram the vCPU timer at time tick X (440). The time tick X can represent a time at which the server 316 is expected to schedule the timer interrupt. In some cases, the time tick X can represent a time that the server 316 is expected to fire the timer interrupt. Upon reprogramming the vCPU timer at time tick X, the server 316 can proceed to operation (465).

If the timer device is configured as a periodic timer for the vCPU, the server 316 can configure a periodic timer interrupt for the vCPU or schedule the vCPU (445). The VM 320 can process pending vCPU events (450). The server 316 can determine whether the periodic timer has been fired (455). If the timer has been fired, the server 316 can record the time tick X, representing the time at which the timer is fired for scheduling the vCPU (460). Upon recording the time tick X at operation (460), the server 316 can proceed to operation (450) to continue processing the pending vCPU events (e.g., by the VM 320). If the periodic timer has not been fired, the server can proceed to operation (465). Firing or executing the periodic timer can refer to scheduling the timer interrupt by at least one of the periodic timer or tickless timer.

The server 316 can determine whether the vCPU has been scheduled by the pCPU of the server 316 (465). The server 316 can loop operation (465) to wait for the pCPU to schedule the vCPU based on one of the reprogrammed vCPU by the tickless timer or by the periodic timer scheduling periodic timer interrupts. For instance, if the host or the server 316 has not scheduled the vCPU, the server 316 can wait at operation (465). In some other cases, if the host has scheduled the vCPU, the server 316 can proceed to operation (470). The host can refer to the server 316 or other servers 316, such as monitored by the device 308, for example. The server 316 can determine that the vCPU is scheduled at time tick Y.

The server 316 can transmit the data associated with the time tick X and time tick Y, or other scheduling data for indicating resource starvation, to the device 308. For example, the Y and X can represent the actual scheduling time and the expected scheduling time, respectively. In another example, the Y and X can represent the actual firing time and the expected firing time of the timer or the timer interrupt, respectively. In some cases, the device 308 can monitor other activities of the server 316 or other servers 316, as in the operations of diagram 400, for example. For example, the device 308 can determine whether the delta between time tick Y and time tick X is greater than (or equal to) the threshold. If there is no scheduling delay or latency, time tick Y can be similar to time tick X (e.g., below a threshold). If there is scheduling latency, the delta between the Y and X can be greater than the threshold. The threshold can be based on at least one of the application, the VM 320, the server 316, the tolerance level, the user, or other configurations, such as configured by the administrator.

In some cases, determining that the delta is greater than the threshold can include the device 308 determining that the count of occurrences when the delta is greater than a first threshold (e.g., latency threshold) is greater than a second threshold (e.g., count threshold). For instance, the device 308 can determine whether the number of times scheduling vCPU is delayed is greater than the count threshold. If the delta is greater than the threshold, the device 308 can proceed to operation (475). Otherwise, the device can proceed to operation (485).

The device 308 or the server 316 can notify the administrator (e.g., of the VM 320 or the server 316) of the vCPU scheduling latency. The device 308 can notify the administrator to provide inputs to a prediction model (e.g., a model trained using historical performance data of the server 316) (475). The input can include at least the historical performance data of the server 316 or individual VMs 320 on the server 316. The input can include data of other servers 316. In some cases, the input can include data on actions the administrator may take to resolve the scheduling latency.

The device 308 can use a machine learning engine or artificial intelligence (AI) processing to determine or perform an action (e.g., corrective action) on the VM 320 (480). For instance, the device 308 can use the model to determine at least future occurrences of scheduling latency. Based on the prediction from the model, the device 308 can perform a process or action at least before or during a time period when the scheduling latencies occur. In some cases, the AI processing can analyze the pattern of responses from the administrator to resolve the scheduling delay. For instance, the action can include at least i) migration of the workload or application to a different VM 320 on the same host, ii) migration of the VM 320 to a different host, iii) migration of the application to a different VM 320 on a different host, or iv) deploy a new VM 320 on a different host to migrate the application.

The AI processing can determine which of the action to take based on historical performance data of the server 316 and the actions by the administrator. For example, the device 308 can use the model to determine the action to take based on at least the historical data of other VMs 320 or servers 316 (e.g., whether occurrences of scheduling delays occur during the time period). The device 308 can determine the action to take for the VM 320 based on historical actions taken on similar VMs 320. The device 308 can determine, based on feedback data, the performance increase or scheduling latency reduction from VMs 320 after initiating the actions. Accordingly, the device 308 can perform corrective action to mitigate latency or packet drop. The device 308 can repeat the process to determine whether the timer is a periodic timer (485), similar to operation (420).

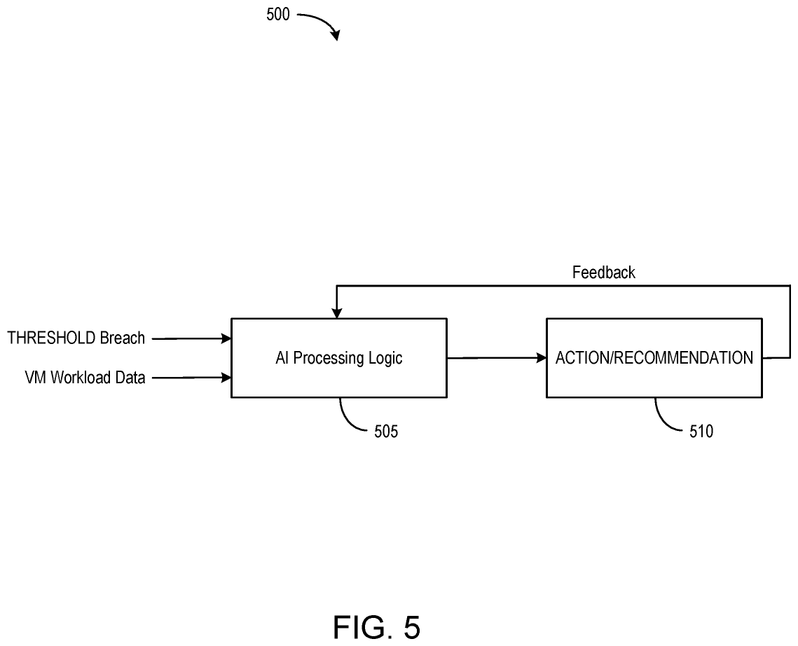

FIG. 5 is an example workflow diagram 500 for orchestrating an action. The diagram 500 can include various operations for orchestrating an action. The example diagram 500 can include operations, which can be executed, performed, or otherwise carried out by one or more components of the system 300 (e.g., device 308, server 316, etc.), the computer 101, the cloud computing environment 214, or any other computing devices described herein in conjunction with FIGS. 1A-2C. For example, the operations can be performed by the server 316 or the device 308 monitoring activities or receiving historical data from the server 316. In another example, the operations can be performed by the device 308 embedded as part of at least one server 316.

The diagram 500 can include an AI processing logic 505 and an action (or recommendation) module 510. For example, the device 308 can use the AI processing logic 505 to process data received from the server 316 (or other servers 316) to determine an action to initiate. In some cases, the AI processing logic 505 can be a part of the orchestrator 340 or other components (e.g., delay detector 328, prioritizer 332, delay predictor 336, etc.) of the device 308. For example, the device 308 can provide the AI processing logic 505 with data associated with threshold breaches and the workload data of the VM 320. The threshold breaches can refer to the number of occurrences that vCPU scheduling was delayed. In some cases, the threshold breaches can indicate the number of times occurrences of scheduling latency exceeds a threshold. The AI processing logic 505 can determine the resource consumption or bandwidth usage of the VM 320 based on the workload data.

The AI processing logic 505 can provide a recommended action to the action module 510 in response to the count of occurrences greater than or equal to a threshold. The AI processing logic 505 can instruct the action module 510 to execute the action before or during the time period of latency. In some cases, the AI processing logic 505 can determine a predicted time period of scheduling latency occurrences. In this case, the AI processing logic 505 may provide an action to the action module 510 to execute at a future time period. The AI processing logic 505 can recommend the action based at least on historical performance data of the VM 320, the server 316, or other servers 316 to determine whether other VMs 320 or servers 316 are available to handle the workload of the VM 320. The AI processing logic 505 can factor in the tolerance level of the VM 320 or application executing on the VM 320, the user, or other information to select at least one of the processes to initiate. In response to selecting at least one of the processes, the AI processing logic 505 can instruct the action module 510 to initiate the action.

The action module 510 can initiate the action to one or more VMs 320 and provide feedback data of the action to the AI processing logic 505. For example, the action module 510 can migrate the workload from the VM 320 to a second VM. The second VM can be in the same server 316 or a different server 316. In some cases, the action module 510 can generate a new VM 320 on a different server 316 to migrate the workload. Upon initiating the action, the action module 510 can transmit or forward feedback data received from the VM 320 to the AI processing logic 505. The feedback data can indicate any scheduling latency information, resource starvation, or packet drop rate on the new VM 320 or server 316 at different time periods.

The AI processing logic 505 can receive the feedback data from the action module 510. The AI processing logic 505 can update the model to predict future occurrences of latency. The AI processing logic 505 can update the model to provide updated actions based on the threshold breaches or historical performance data of the VM 320. In some cases, the AI processing logic 505 can determine that resource starvation or scheduling latency persists on the VM 320 after the action was taken. In this case, the AI processing logic 505 can initiate a different action for the VM 320. The device 308 may initiate the action automatically without manual intervention.

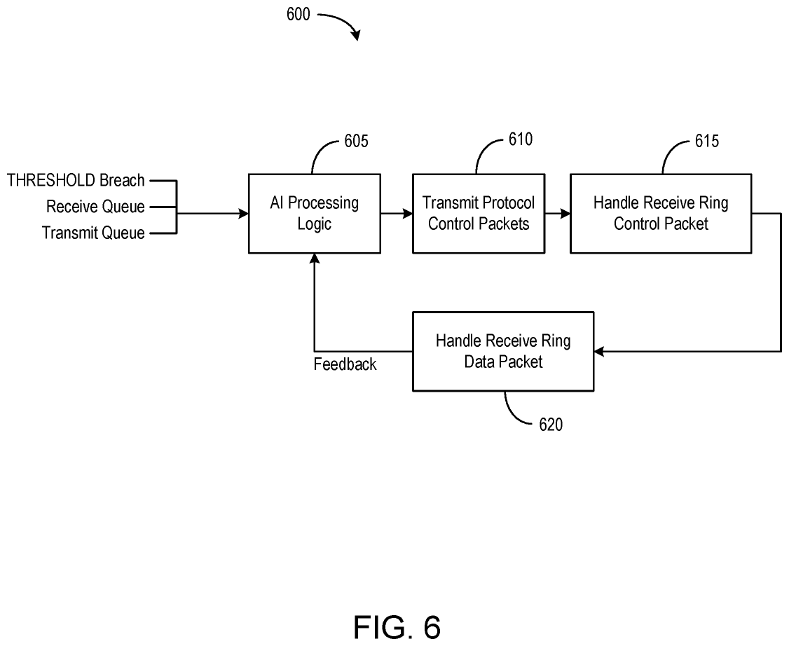

FIG. 6 is an example workflow diagram for handling protocol packets and data packets. The diagram 600 can include various operations for handling protocol packets and data packets. The example diagram 600 can include operations, which can be executed, performed, or otherwise carried out by one or more components of the system 300 (e.g., device 308, server 316, etc.), the computer 101, the cloud computing environment 214, or any other computing devices described herein in conjunction with FIGS. 1A-2C. For example, the operations can be performed by the server 316 or the device 308 monitoring activities or receiving historical data from the server 316. In another example, the operations can be performed by the device 308 embedded as part of at least one server 316.

The diagram 600 can include an AI processing logic 605 to perform one or more operations to handle packets in the receive or transmit queue. The AI processing logic 605 can be similar to the AI processing logic 505 in conjunction with FIG. 5. For instance, the AI processing logic 605 can perform one or more features or functionalities of a machine learning engine, a model trained using the performance data, or one or more components of the device 308. In some cases, the device 308 can use the AI processing logic 605 to perform the operations. For example, the device 308 can provide historical data as inputs for the AI processing logic 605 to process. The historical data can include at least the threshold breaches, receive queue, and transmit queue data associated with the VM 320 or the server 316. In some cases, the device 308 can provide feedback data to the AI processing logic 605. The feedback data can be from previous initiations of the prioritization process for packets in the queue the VM 320.

The AI processing logic 605 can process the historical data to determine types of packets (e.g., protocol control packets or data packets) in the Rx queue or Tx queue. For example, the device 308, using the AI processing logic 605, can determine any control packet pending the Tx queue before or during a time period of scheduling latency. The device 308 can prioritize the control packets. The device 308 can transmit the control packets in the Tx queue in response to identifying the control packet during or before scheduling latency (610).

The device 308 can identify different types of packets in the Rx queue. The device 308 can prioritize the control packet in the Rx queue. For instance, the device 308 can rearrange the queue, such that the control packets can be processed or handled (615) before the data packets. Upon handling the protocol packets, the device 308 can proceed to handle the data packets reset to positions after the protocol packets (620). For example, the device 308 may scan through the Rx queue to determine a first packet to the last packet in the queue. The device 308 can reset the position of any data packet in the queue (e.g., send to the back of the queue). The device 308 can maintain the position of the protocol packet in the queue. Accordingly, from scanning through the queue, the protocol packet(s) can be brought to the front of the queue to be processed immediately before data packets.

The device 308 can provide feedback data to the AI processing logic 605. The feedback data can include the prioritization processes or actions. Based on the feedback data, the AI processing logic 605 can determine the reduction of packet drop, connection loss, or downtime by taking the prioritization process during the scheduling latency compared to without the prioritization process. In some cases, the AI processing logic 605 can initiate an adjustment of Rx or Tx queue size during scheduling latency. For instance, the AI processing logic 605 can increase the queue size during the scheduling latency based on the traffic of the application executing on the VM 320. The AI processing logic 605 may decrease the queue size (e.g., back to original queue size) after the scheduling latency time period.

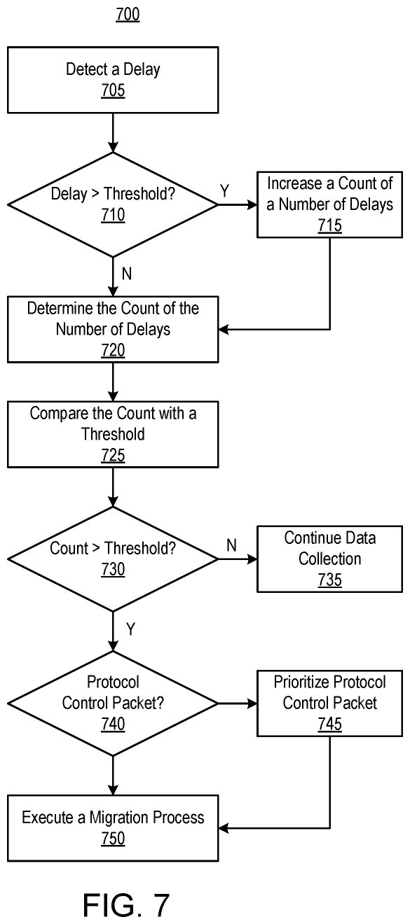

FIG. 7 illustrates an example flow diagram of a method 700 for detecting and predicting virtual CPU resource starvation of a virtual machine. The example method 700 can be executed, performed, or otherwise carried out by one or more components of the system 300 (e.g., device 308, server 316, VM 320, etc.), the computer 101, the cloud computing environment 214, or any other computing devices described herein in conjunction with FIGS. 1A-2C. The method 700 can include a device detecting a delay, at step 705. At step 710, the device can determine whether the delay is greater than (or equal to) the threshold. At step 715, the device can increase the count of a number of delays. At step 720, the device can determine the count of the number of delays. At step 725, the device can compare the count with a threshold. At step 730, the device can determine whether the count is greater (or equal to) a threshold. At step 735, the device can continue collecting data. At step 740, the device can determine whether a packet is a protocol control packet. At step 745, the device can prioritize protocol control packet. At step 750, the device can execute a migration process. For the purposes of providing examples, the logical operations discussed in steps 705-750 can be performed by a delay detector, prioritizer, delay predictor, orchestrator, AI processing logic, action module, or VM in conjunction with other components of the device or server in conjunction with FIGS. 3-6.

Still referring to FIG. 7 in further detail, at step 705, the device can detect a delay of vCPU scheduling by a host system (e.g., a server, pCPU of the server, or a virtualized environment). The device can calculate the delay based on a delta between an expected time and an actual time of scheduling or firing the timer or executing the timer interrupt scheduled by the timer device associated with a VM.

At step 710, the device can determine whether the delay is greater than (or equal to) the threshold. In this example, the threshold can include or correspond to a first threshold or a latency threshold for detecting whether the scheduling delay should be counted as a delay. The latency threshold can be determined based on at least the tolerance level of the application, the VM, or the user. In some cases, the tolerance level can be configured by the administrator of the VM. The threshold may be high based on a high tolerance level, such as 500 ms, 1 second, etc. The threshold may be low based on a low tolerance level, such as 50 ms, 100 ms, 200 ms, etc. If the scheduling delay is greater than the latency threshold, the device can proceed to step 715. Otherwise, the device can proceed to step 720.

At step 715, the device can increase the count of a number of delays. For instance, the device can increase the count of scheduling latency occurrences experienced by the VM. The count can be associated with a VM. In some cases, the count can be associated with multiple VMs hosted by the host system. The device can store the count in the database, including a list of VMs on the host system and the occurrences of scheduling latency experienced in predetermined time periods (e.g., hourly, daily, weekly, etc.). In some cases, the time period can be associated with the day of the week, the month of the year (e.g., indicating holidays), etc.

At step 720, the device can determine the count of the number of delays in occurrences of a timer interrupt scheduled for a vCPU of a VM executing an application. The device can determine the count of the number of delays within a time period. The time period may refer to a time frame at which the device detects the occurrences of scheduling latency or a predicted time when the scheduling latency will occur. The scheduling latency can be associated with the application executing on the VM or using resources of the vCPU. The device can access the database to retrieve or identify the number of occurrences of scheduling latency for individual VMs. The device can determine the count in response to detecting a scheduling latency or periodically. For instance, the device can be configured to determine the count every 20 minutes, 40 minutes, 1 hour, among other times to determine whether an action should be performed for the VM. In some cases, the device can check for scheduling latency at a time interval.

At step 725, the device can compare the count with a threshold. The threshold can be referred to as a second threshold or a count threshold. The device can determine the count threshold (or the latency threshold) based on at least one of a time of day associated with the time period of the occurrences of the scheduling delay, the application executing on the VM, the model trained using historical performance data, among others. The model can use the historical performance data associated with one or more vCPU of the one or more VMs executing on the pCPU of the host system (e.g., the server). The model can be trained to determine whether the threshold should be configured based on the historical performance data of the vCPU. For instance, the device can use the model to increase the threshold during a high traffic time period, for one or more users who consume an above-average amount of resources using the application, etc. In some cases, the count threshold can be adjusted or configured (e.g., increased or decreased) similar to the latency threshold. In some cases, an adjustment to the count threshold may not affect the latency threshold, and vice versa.

The device can use the count threshold to determine whether to perform a corrective action for the VM. The corrective action can be performed to mitigate resource starvation, redistribute traffic among the host systems, mitigate packet drop, or minimize vCPU scheduling latency, for example. In some cases, the device can compare the count with a threshold at a time period in the future (e.g., future time period). For example, the device can use a model trained with historical timer interrupt data or other historical performance data of the VM, vCPU, or host system. Based on the model, the device can predict the count of the number of delays for future time periods. The device can compare the count of scheduling delays to a threshold for the various future time periods to determine whether to perform at least one action before or during a future time period. Accordingly, the device can determine the count of the number of delays, compare the count to a threshold, and determine an action to perform for the time period (e.g., current time period or future time period). The threshold may be established for any time period, such as the time period when the latency is detected or at future time period when the latency may occur.

At step 730, the device can determine whether the count is greater (or equal to) a latency threshold. The device can determine to proceed to step 735 if the count is less than a threshold. Otherwise, the device can proceed to step 740. For instance, the device can determine that the count is less than a threshold. Accordingly, at step 735, the device can proceed to a next time period, the next VM, or other host systems to continue data collection. The device can continue the data collection process to determine any scheduling latency or resource starvation.

At step 740, the device can determine whether a packet is a protocol control packet. In some cases, the device may prioritize one or more packets in the transmit or receive queue of the VM upon detection or determining of scheduling latency at a time period. In some other cases, the device may not perform a prioritization process and proceed to step 750. For example, the device can determine to perform a prioritization process before or during a time period of scheduling latency. The device can determine whether the transmit queue or the receive queue has at least one protocol control packet. If the queue includes a protocol control packet, the device can proceed to step 745. Otherwise, the device can proceed to step 750.

At step 745, the device can prioritize a protocol control packet. For instance, the device can instruct the bus adapter to prioritize the transmission or reception of the protocol control packets. The device can instruct a bus adapter for the VM to transmit protocol control packets in response to the count of the number of delays greater than or equal to the threshold. The bus adapter for the VM can transmit the protocol control packet during the time period of scheduling latency. In some cases, instructing the bus adapter to perform the operation or process may include or be a part of the device performing the process to prioritize the protocol control packet (sometimes referred to generally as control packets). To immediately transmit the control packets from the transmit queue, the device can move the control packet up the queue, or reset the data packet queue position. In some cases, by instructing the bus adapter to transmit a packet, the device can transition the control packet out of the queue to the bus adapter for transmission. In some cases, the device can scan through packets in the transmit queue (or the receive queue) to identify any control packet within the queue.

In some cases, the device can prioritize control packets in the receive queue. For instance, during a time period of scheduling latency, the device can detect one or more control packets. Upon detection of the control packets, the device can move the packets to the front of the queue for processing. In some cases, the device can retrieve the packet from the queue during scheduling latency to process the packet in response to (or immediately after) identifying the control packet. Subsequent to prioritizing the packet, the device can proceed to step 750.

In some cases, the device can instruct the bus adapter to modify the depth of the queue. For example, the device can increase the queue depth of the bus adapter in response to transmitting an instruction to the bus adapter. The device can increase the queue depth in response to determining that the time period is associated with occurrences of scheduling latency greater than the count threshold, for example. In some cases, the device can increase the queue depth based on one or more detections of packet drops (e.g., packet drop rate greater than a threshold). The device may decrease the queue of the depth at time period without scheduling latency or packet drop.

At step 750, the device can execute, perform, or initiate a migration process. The device can execute a migration process or other processes to avoid, mitigate, or reduce scheduling latency or resource starvation which causes connection loss, downtime, or protocol re-convergence. The device can determine a migration process to execute based at least on one of the tolerance level of the application, resource consumption of the application, available resources of other VMs or host systems, or historical performance data of the other VMs or host systems (e.g., whether other VMs or host systems experiences latency during the time period), among other data.

For example, the device can identify a second VM that is associated with a second vCPU. The second VM may be hosted by the same host system as the VM executing the application. In some cases, the second VM may be hosted by a different host system. The device can determine to execute a process to migrate the application to a second VM based at least on the comparison of the count of the number of delays with the threshold.

In further example, the device can determine a second count of the number of delays within the time period in occurrences of a second timer interrupt scheduled for a second vCPU of a second VM. The device can determine that the second count is less than the count threshold (or a second count threshold) at the time period. Determining that the second could is less than the threshold can indicate that the second VM can handle executing the application from a first VM without experiencing scheduling latency greater than the threshold. In some cases, the second count threshold may be different from the count threshold used to compare the count of occurrences of scheduling delay for a first vCPU. For example, the second count threshold associated with a second VM can be less than the first count threshold of a first VM, such that the device can minimize occurrences of the scheduling delay after migration. In some cases, the first count threshold and the second count threshold may be similar. Accordingly, the device can migrate the application to the second VM based on the comparison of the count to the threshold (e.g., the first count of the first VM to the first count threshold or the second count of the second VM to the second count threshold). The second VM may be hosted on the same host system.

In some cases, the device can migrate the first VM to a different host system that does not experience the scheduling latency during the time period. In some cases, the device can migrate the application or workload from the first VM to a second VM on a different host system, which does not experience scheduling latency during the time period. In some cases, the device can determine to migrate the application to a different host system that does not have any available VMs. In this example, the device may launch (or instruct the host system to launch) a second VM in response to the count of the number of delays greater than the count threshold. Upon the launch of the second VM, the device can migrate the application to the second VM on the second host system. In some cases, the second VM may be launch in the same host system. Accordingly, by performing at least one of the migration processes or the prioritization process, the device can mitigate or minimize at least scheduling latency, resource starvation (e.g., by redistribution of traffic), packet drops, connection loss, downtime, or protocol re-convergence.

### Further Example Embodiments

The following examples pertain to further embodiments, from which numerous permutations and configurations will be apparent.

Example 1 includes a method comprising: determining, by one or more processors, within a time period a count of a number of delays in occurrences of a timer interrupt scheduled for a virtual processor of a virtual machine executing an application; comparing, by the one or more processors, the count of the number of delays with a threshold established for the time period; and executing, by the one or more processors, a process to migrate the application to a second one or more processors based at least on the comparison of the count of the number of delays with the threshold.

Example 2 includes the subject matter of Example 1, comprising: determining, by the one or more processors, the threshold based on a time of a day associated with the time period.

Example 3 includes the subject matter of any of Examples 1 and 2, comprising: determining, by the one or more processors, the threshold based on the application executed by the virtual machine.

Example 4 includes the subject matter of any of Examples 1 through 3, comprising: determining, by the one or more processors, the threshold based on a model trained using historical performance data associated with one or more virtual processors of one or more virtual machines executed by the one or more processors.

Example 5 includes the subject matter of any of Examples 1 through 4, wherein the time period comprises a future time period, and determining the count of the number of delays comprises: predicting, by the one or more processors using a model trained with historical timer interrupt data, the count of the number of delays for the future time period.

Example 6 includes the subject matter of any of Examples 1 through 5, wherein the process comprises: determining, by the one or more processors, a second count of a number of delays within the time period in occurrences of a second timer interrupt scheduled for a second virtual processor of a second virtual machine; and migrating, by the one or more processors based on the comparison of the count of the number of delays with the threshold, the application to the second virtual machine.

Example 7 includes the subject matter of any of Examples 1 through 6, wherein the second virtual machine is hosted by the one or more processors.

Example 8 includes the subject matter of any of Examples 1 through 7, wherein the process comprises: launching, by the one or more processors, a second virtual machine responsive to the count of the number of delays greater than the threshold; and migrating, by the one or more processors, the application to the second virtual machine.

Example 9 includes the subject matter of any of Examples 1 through 8, wherein the process comprises: migrating, by the one or more processors, the virtual machine to the second one or more processors.

Example 10 includes the subject matter of any of Examples 1 through 9, comprising: instructing, by the one or more processors responsive to the count of the number of delays greater than or equal to the threshold, a bus adapter for the virtual machine to perform at least one of: prioritizing, by the bus adapter, transmission and reception of protocol control packets, or increasing, by the bus adapter, a queue depth of the bus adapter.

Example 11 includes a system, comprising: one or more processors of a device to: determine within a time period a count of a number of delays in occurrences of a timer interrupt scheduled for a virtual processor of a virtual machine executing an application; compare the count of the number of delays with a threshold established for the time period; and execute a process to migrate the application to a second one or more processors based at least on the comparison of the count of the number of delays with the threshold.

Example 12 includes the subject matter of Example 11, wherein the one or more processors are further configured to: determine the threshold based on a time of a day associated with the time period.

Example 13 includes the subject matter of any of Examples 11 and 12, wherein the one or more processors are further configured to: determine the threshold based on the application executed by the virtual machine.

Example 14 includes the subject matter of any of Examples 11 through 13, wherein the one or more processors are further configured to: determine the threshold based on a model trained using historical performance data associated with one or more virtual processors of one or more virtual machines executed by the one or more processors.

Example 15 includes the subject matter of any of Examples 11 through 14, wherein the time period comprises a future time period, and the one or more processors are further configured to: predict, using a model trained with historical timer interrupt data, the count of the number of delays for the future time period to determine the count.

Example 16 includes the subject matter of any of Examples 11 through 15, wherein the one or more processors execute the process to: determine a second count of a number of delays within the time period in occurrences of a second timer interrupt scheduled for a second virtual processor of a second virtual machine; and migrate, based on the comparison of the count of the number of delays with the threshold, the application to the second virtual machine.

Example 17 includes the subject matter of any of Examples 11 through 16, wherein the one or more processors execute the process to: launch a second virtual machine responsive to the count of the number of delays greater than the threshold; and migrate the application to the second virtual machine.

Example 18 includes the subject matter of any of Examples 11 through 17, wherein the one or more processors are further configured to: instruct, responsive to the count of the number of delays greater than or equal to the threshold, a bus adapter for the virtual machine to perform at least one of: prioritize transmission and reception of protocol control packets, or increase a queue depth of the bus adapter.

Example 19 includes a non-transitory computer readable medium storing instructions that, when executed by one or more processors, cause the one or more processors to: determine within a time period a count of a number of delays in occurrences of a timer interrupt scheduled for a virtual processor of a virtual machine executing an application; compare the count of the number of delays with a threshold established for the time period; and execute a process to migrate the application to a second one or more processors based at least on the comparison of the count of the number of delays with the threshold.

Example 20 includes the subject matter of Example 19, wherein the instructions further comprise instructions to: determine the threshold based on a time of a day associated with the time period.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method, comprising:
determining, by one or more processors, within a time period a count of a number of delays in occurrences of a timer interrupt scheduled for a virtual processor of a virtual machine executing an application;
comparing, by the one or more processors, the count of the number of delays with a threshold established for the time period; and
executing, by the one or more processors, a process to migrate the application to a second one or more processors based at least on the comparison of the count of the number of delays with the threshold.

2. The method of claim 1, comprising:
determining, by the one or more processors, the threshold based on a time of a day associated with the time period.

3. The method of claim 1, comprising:
determining, by the one or more processors, the threshold based on the application executed by the virtual machine.

4. The method of claim 1, comprising:
determining, by the one or more processors, the threshold based on a model trained using historical performance data associated with one or more virtual processors of one or more virtual machines executed by the one or more processors.

5. The method of claim 1, wherein the time period comprises a future time period, and determining the count of the number of delays comprises:
predicting, by the one or more processors using a model trained with historical timer interrupt data, the count of the number of delays for the future time period.

6. The method of claim 1, wherein the process comprises:
determining, by the one or more processors, a second count of a number of delays within the time period in occurrences of a second timer interrupt scheduled for a second virtual processor of a second virtual machine; and
migrating, by the one or more processors based on the comparison of the count of the number of delays with the threshold, the application to the second virtual machine.

7. The method of claim 6, wherein the second virtual machine is hosted by the one or more processors.

8. The method of claim 1, wherein the process comprises:
launching, by the one or more processors, a second virtual machine responsive to the count of the number of delays greater than the threshold; and
migrating, by the one or more processors, the application to the second virtual machine.

9. The method of claim 1, wherein the process comprises:
migrating, by the one or more processors, the virtual machine to the second one or more processors.

10. The method of claim 1, comprising:
instructing, by the one or more processors responsive to the count of the number of delays greater than or equal to the threshold, a bus adapter for the virtual machine to perform at least one of:
prioritizing, by the bus adapter, transmission and reception of protocol control packets, or increasing, by the bus adapter, a queue depth of the bus adapter.

11. A system, comprising:
one or more processors of a device to:
determine within a time period a count of a number of delays in occurrences of a timer interrupt scheduled for a virtual processor of a virtual machine executing an application;
compare the count of the number of delays with a threshold established for the time period; and
execute a process to migrate the application to a second one or more processors based at least on the comparison of the count of the number of delays with the threshold.

12. The system of claim 11, wherein the one or more processors are further configured to:
determine the threshold based on a time of a day associated with the time period.

13. The system of claim 11, wherein the one or more processors are further configured to:
determine the threshold based on the application executed by the virtual machine.

14. The system of claim 11, wherein the one or more processors are further configured to:
determine the threshold based on a model trained using historical performance data associated with one or more virtual processors of one or more virtual machines executed by the one or more processors.

15. The system of claim 11, wherein the time period comprises a future time period, and the one or more processors are further configured to:
predict, using a model trained with historical timer interrupt data, the count of the number of delays for the future time period to determine the count.

16. The system of claim 11, wherein the one or more processors execute the process to:
determine a second count of a number of delays within the time period in occurrences of a second timer interrupt scheduled for a second virtual processor of a second virtual machine; and
migrate, based on the comparison of the count of the number of delays with the threshold, the application to the second virtual machine.

17. The system of claim 11, wherein the one or more processors execute the process to:
launch a second virtual machine responsive to the count of the number of delays greater than the threshold; and
migrate the application to the second virtual machine.

18. The system of claim 11, wherein the one or more processors are further configured to:
instruct, responsive to the count of the number of delays greater than or equal to the threshold, a bus adapter for the virtual machine to perform at least one of:
prioritize transmission and reception of protocol control packets, or
increase a queue depth of the bus adapter.

19. A non-transitory computer readable medium storing instructions that, when executed by one or more processors, cause the one or more processors to:
determine within a time period a count of a number of delays in occurrences of a timer interrupt scheduled for a virtual processor of a virtual machine executing an application;
compare the count of the number of delays with a threshold established for the time period; and
execute a process to migrate the application to a second one or more processors based at least on the comparison of the count of the number of delays with the threshold.

20. The computer readable medium of claim 19, wherein the instructions further comprise instructions to:
determine the threshold based on a time of a day associated with the time period.
